(19) United States
(12) Patent Application Publication
(10) Pub. No.: US 2024/0383033 A1
(43) Pub. Date: Nov. 21, 2024

(54) SYNTHESIS AND APPLICATIONS OF CHIRAL METAL AND HYBRID NANOSTRUCTURES

(71) Applicant: UNIVERSITY OF MARYLAND, COLLEGE PARK, College Park, MD (US)

(72) Inventors: Min OUYANG, N. Bethesda, MD (US); Hanyu LIU, Hyattsville, MD (US)

(21) Appl. No.: 18/653,798

(22) Filed: May 2, 2024

Related U.S. Application Data
(60) Provisional application No. 63/499,708, filed on May 2, 2023.

(51) Int. Cl. B22F 1/054; B22F 9/24; B82Y 40/00

(52) U.S. Cl. CPC B22F 1/0553; B22F 9/24; B82Y 40/00; B22F 2301/255; B22F 2302/45

(57) ABSTRACT

The present disclosure provides a class of chiral metal nanomaterials having controllable imbalanced chiral facets on their surfaces and preparation method thereof. Also provided is a method of preparing a chiral hybrid nanomaterial comprising chiral metal core with imbalanced chiral facets and semiconductor shell. Advantageously, the present chiral metal nanomaterials may be useful in the design and fabrication of other functional materials and devices with tailored chirality.

### CROSS-REFERENCE TO RELATED APPLICATIONS

This application claims the benefit of U.S. Provisional Patent Application Ser. No. 63/499,708 filed on May 2, 2023, the content of which is incorporated by reference herein in its entirety.

### STATEMENT REGARDING FEDERALLY SPONSORED RESEARCH

This invention was made with government support under DE-SC0010833 awarded by the U.S. Department of Energy. The government has certain rights in the invention.

### BACKGROUND

Chirality (or handedness), the property of asymmetry in an object that cannot be superimposed onto its mirror image, plays a fundamental role in various fields, and has garnered increasing attention in chemistry, physics, materials science and nanotechnology. In recent years, inorganic chiral nanomaterials have emerged as a significant area of interest due to their intriguing chirality-dependent properties and important applications in various fields. Inorganic chiral nanomaterials encompass a diverse range of materials, exhibiting chirality either intrinsically or extrinsically. The development of strategies and mechanisms for the growth and assembly of inorganic chiral nanomaterials has been a subject of intensive research. Despite significant progress in the field, challenges remain in achieving precise control over the robustness of chirality, size, morphology of inorganic chiral nanomaterials, as well as understanding the underlying mechanisms governing their chirality-dependent properties and functionalities. Addressing these challenges is essential for unlocking the full potential of these materials and realizing their impact in various technological domains.

Thus, there remains a need for alternative chiral inorganic nanomaterials with controllable structural features and the synthetic methods thereof.

### SUMMARY OF THE INVENTION

In one aspect, the present disclosure provides a chiral metal nanomaterial comprising a metal forming a nanostructure having controllable imbalanced chiral facets on the surface of the nanostructure. The metal can be, for example, gold, platinum, cobalt, copper, nickel, silver, iron, palladium, aluminum, tin, lead, or alloys thereof. The nanostructure can include nanocubes, nanorods, nanocuboctahedra, nanooctahedra, nano-triangular plates, nano-hexagonal plates, nanobars, nanodendrites, nano-bi pyramids, nanodecahedra, nano-icosahedrons, nanopolyhedrons, nanocages, nano-rhombic dodecahedra, nanotetrahedrons, nanobeams, or a combination thereof.

In another aspect, the present disclosure provides a method of preparing a chiral metal nanomaterial having controllable imbalanced chiral facets. The method can comprise mixing a seed metal nanomaterial, a chiral organic compound, a surfactant, reducing agent, and a metal precursor to form a growth medium, whereby the chiral metal nanomaterial having controllable imbalanced chiral facets is produced.

In another aspect, the present disclosure provides a chiral metal nanomaterial produced by the preparation method as described herein.

In another aspect, the present disclosure provides a method of producing a chiral hybrid nanomaterial comprising chiral metal and semiconductor. The chiral hybrid nanomaterial can comprise a chiral metal core that possesses unique imbalanced chiral facets on its surface and semiconductor shell. The method can comprise (a) mixing a chiral metal nanomaterial with a silver salt, a surfactant, and a reducing agent in a first medium, thereby producing an intermediate hybrid nanomaterial comprising silver (e.g., as a silver shell), wherein the chiral metal nanomaterial comprises a metal forming a nanostructure having controllable imbalanced chiral facets on the surface of the nanostructure. The method can further comprise (b) mixing the intermediate nanomaterial with an anion X in a second medium, thereby producing a first chiral hybrid nanomaterial comprising Ag—X semiconductor. In some embodiments, the method can further comprise (c) mixing the first chiral hybrid nanomaterial comprising Ag—X semiconductor and a cation M′ in a third medium, thereby producing a second chiral hybrid nanomaterial comprising M′-X semiconductor. In some embodiments, X is O²⁻, S²⁻, Se²⁻, or Te²⁻, or a combination thereof. In some embodiments, M′ is Cu⁺, Au⁺, Cd²⁺, Zn²⁺, Mn²⁺, Fe²⁺, Co²⁺, Al³⁺, Ag⁺, Sn²⁺, Ni⁺, Pt⁺, Pd⁺, or Pb²⁺, or a combination thereof. In embodiments, the Ag—X semiconductor is Ag₂S, Ag₂Se, or Ag₂Te. In some embodiments, the M′-X semiconductor is CdS, CdSe, or CdTe.

In yet another aspect, the present disclosure provides a chiral hybrid nanomaterial comprising semiconductor produced by the method as described herein.

### BRIEF DESCRIPTION OF THE DRAWINGS

Further objects, features and advantages of the present disclosure will become apparent from the following detailed description taken in conjunction with the accompanying figures showing illustrative embodiments of the present disclosure. Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention.

The patent or application file contains at least one drawing executed in color. Copies of this patent or patent application publication with color drawing(s) will be provided by the Office upon request and payment of the necessary fee.

FIG. 1 shows the schematic of controlled bottom-up growth of chiral inorganic materials and their enabled chiral hybrid nanostructures. Red and blue represent high-Miller-index chiral S- and R-crystallo-graphic planes, respectively. Small chiral organic molecules are employed to break the structural symmetry and to enable enantiomerically pure chiral boundary morphology to induce crystallographic handedness in inorganic materials. The robustness of chiral boundary morphology of inorganic materials can allow integration of multiple components (yellow block) by the formation of hybrid nanostructures, possessing interfacial chirality coupling (green arrows).

FIG. 2 shows the synthesis and characterizations of chiral Au NCs. (a) Typical large-scale TEM image of chiral S—Au NCs. Scale bar=100 nm. (b) Typical TEM image of individual S—Au NC. A few inhomogeneous features on the surface are highlighted by red arrow. Scale bar=20 nm. (c) Experimental CD spectra of S (red)- and R (blue)-Au NCs. (d) Experimental extinction spectra of S (red)- and R (blue)-Au NCs.

FIG. 3 shows the angle-dependent high-resolution SEM characterizations and modeling of chiral Au NCs. (a) (Top) SEM images of single S—Au NC under three different viewing angles. Scale bar=20 nm. (Bottom) Corresponding structural model. (b) Schematic showing the formation of S (left)- and R (right)-chiral NCs facilitated by the prevailing chiral high-Miller-index facets on the surface due to chiral symmetry breaking from an achiral NC (middle). Small green filled circles as guide to the eyes highlight the twisted edges on the boundary. (c, d) Computed CD and extinction spectra of S (red)- and R (blue)-chiral Au NCs by using the structural model presented in panel (a), respectively. (e) more angle-dependent characterization of chiral Au NC. (Top) SEM images of same chiral Au NC presented in (a) but under different tilting and rotating angles. Scale bar=20 nm. (Bottom) Corresponding structural models presented under each SEM image for comparison.

FIG. 4 shows the synthesis, characterizations, and modeling of chiral Au NRs. (a) Schematic showing that, by breaking the symmetry of enantiomeric high-Miller-index facets (red and blue colors represent chiral crystallographic S- and R-facets, respectively) at the ends of achiral NR (middle), chiral S (left)- and R (right)-NRs can be formed by the prevailing chiral facets at the ends, while its elongated side consists of symmetric low-Miller-index facets (gray color) as those of achiral NR. (b) Typical large-scale TEM image of chiral S—Au NRs. Scale bar=100 nm. (c) (Left) High-resolution TEM image of single chiral S—Au NR. (Middle top) Atomic resolved TEM image of the green region on the left image. Scale bar=2 nm. (Middle bottom) FFT pattern of the side of NRs. The side facets of the chiral NR are identified by both imaging and indexing the FFT pattern. (Right) Constructed structural model of a chiral S—NR. (d) Experimental CD (left) and extinction (right) spectra of chiral S (red)- and R (blue)-Au NRs. (c) Computed CD (left) and extinction (right) spectra of chiral S (red)- and R (blue)-Au NRs by using the structural model in panel (c).

FIG. 5 shows the dependence of the chiroptical response of chiral Au NRs on the AR and the apex protrusions. (a, b) Evolution of peak wavelengths in CD and extinction spectra with the AR, respectively. Both transverse (green spheres) and longitudinal peaks (orange spheres) are presented and compared. The green and orange lines are data from simulation for transverse and longitudinal peaks, respectively. (c, d) Evolution of peak wavelengths in CD and extinction spectra with the average number of protrusion features at the ends of chiral NRs, respectively. Both transverse (green spheres) and longitudinal peaks are presented and compared. The cyan upper and down triangles are simulation data for longitudinal and transverse peaks, respectively. The experimental uncertainty of the AR is determined by counting more than 500 nanostructures from TEM images of each sample. The experimental uncertainty of the peak wavelength is estimated by the Gaussian peak fit error.

FIG. 6 shows the development and characterization of chiral hybrid nanostructures. (a) Step-by-step chiral structural evolution (top to bottom in figure) from chiral metal Au NRs with bone-shaped morphology to Au—Ag core-shell, to Au—Ag₂S, and to Au—CdS metal-semiconductor core-shell NRs by chemical conversion. For every step, solution in a glass vial showing good sample dispersion and color (left), TEM image of individual nanostructure with scale bar of 20 nm (middle), and its corresponding model (right) are presented. (b) Experimental dissymmetry g-factor measured at each step. Purple, pink, gray, and yellow data curves were acquired from the Au, Au—Ag, Au—Ag₂S, and Au—CdS NRs, respectively. For comparison and clarity purpose, the curves of the Au—Ag, Au—Ag₂S, and Au—CdS NRs are vertically shifted by −0.006, −0.0105, and −0.0155, respectively.

FIG. 7 shows the designation of high Miller index chiral facets in a crystalline lattice. (a) Unit spherical representation of atomic fcc lattice (small spheres at the center). Any single point on the surface can define a zone axis of crystalline plane. Black curves highlight all the crystalline planes that possess at least one mirror symmetry. The regions lying off the mirror zones are designated by two different colors, light blue and light red, to represent sets of R- and S-chiral planes, respectively. (b) Construction of enantiomeric crystalline plane (top) by following notation in (A), with enantiospecific interaction with small chiral organic molecules (bottom). Red (S—) and Blue (R—) represent chiral planes, having enantioselective binding with D- and L-chiral molecules, respectively. (c) Atomic model of exemplary chiral R-(321) and S-(321) facets showing that the kinked site (green filled circles) of step edges in a high Miller index plane behaves as a “chiral center”, leading to the chirality.

FIG. 8 shows the achiral Au NCs as seeds for growing chiral Au NCs. Typical TEM image. Scale bar=100 nm. Inset shows a single achiral NC with scale bar of 20 nm. Straight edges and flat surface of achiral Au seed NCs can be clearly revealed.

FIG. 9 shows a typical SEM image of chiral S—Au NCs assisted by L-cysteine molecules, showing high yields. Scale bar=1 μm.

FIG. 10 shows the model comparisons between S—and R—NCs. Models of S—NC (left) and R—NC (right) in different orientation. Red and blue shades are added to the model to highlight twisted edge boundaries for S—and R—NCs, respectively. Green spheres are used to highlight twisting sites at the edge as presented in FIG. 3.

FIG. 11 shows the experimental TEM image comparison between S—and R—Au NCs. Typical TEM images of individual S—Au NC (left bottom) and R—Au NC (right bottom) are presented and compared. Scale bar=10 nm. In order to understand and compare TEM images, their corresponding models are presented at the top. Blue arrow in the model represents the incident electron beam direction in TEM imaging. Color shades are used to highlight the twisted edge boundaries and corners in different planes in order to guide the comparison between TEM image and its model. Green spheres are used to highlight twisting sites at the edge as presented in FIG. 3.

FIG. 12 shows the SEM images of chiral Au NRs. (a) Image showing concave facets at the ends of NRs (highlighted by red arrows). Scale bar=20 nm. (b) Image showing straight and undistorted concave facets on the side (highlighted by red arrows). Scale bar=20 nm.

FIG. 13 shows the overgrowth of chiral R—Au NRs by using binary surfactants mixture. (a) Typical TEM image showing that overall morphology of Au NRs become more even after the overgrowth. Scale bar=20 nm. (b) Experimental extinction spectra before (red) and after (green) overgrowth. Small red shifts of both traverse and longitudinal peak wavelengths are observed after overgrowth due to the size increase. (c) Experimental CD spectra before (red) and after (green) overgrowth. (d) and (e) show experimental optical spectra of chiral Au NRs with different AR. (d) CD spectra. (c) Extinction spectra. Data were acquired from samples summarized in (a)-(c). (f) and (g) show control of structural protrusions at the apex of chiral Au NRs. (f) Typical large-scale TEM images of chiral Au NRs with different number of protrusions at the ends of Au NRs. Three examples, 0 protrusion, 2 protrusions and bone-shape are presented to show the overall quality of samples in this control experiment. Scale bar=100 nm. (g) Representative TEM image and structural model of individual chiral Au NRs with evolution of different number of protrusions at the ends. For model, side view and two end views are provided for clarification purpose. These are also the models utilized for FEM computation presented in (d) and (c).

FIG. 14 shows the evolution of optical properties of chiral Au NRs with the AR by FEM simulation. (a) & (b) Simulated CD and extinction spectra as function of the AR of chiral Au NRs, respectively.

FIG. 15, (a) and (b) show the tuning of the AR of chiral Au NRs. (a) Typical large-scale TEM images of chiral Au NRs with two different averaged ARs of 1.8 (top) and 3.1 (bottom). Scale bar=100 nm. (b) TEM image and model of individual chiral Au NRs showing structural evolution with the AR. Structural model for each AR is also used for FEM computation in (c) . . . (c) Angle-dependent TEM characterization of chiral Au NRs. No axial distortion of chiral NR Is confirmed by different angle view. Scale bar=20 nm. (d)-(g) show the CD and extinction spectra of chiral Au NRs with different number of protrusions at the ends. (d) & (e) Experimental CD and extinction spectra, respectively. (f) & (g) Computed CD and extinction spectra by using the model presented in (a) and (b), respectively.

FIG. 16 shows step-by-step optical characterization of hybrid chiral NRs by chemical conversion. (a) & (b) Experimental CD and extinction spectra, respectively. Purple, pink, gray and yellow data curves are acquired from Au, Au (core)-Ag (shell), Au (core)-Ag₂S (shell) and Au (core)-CdS (shell) NRs, respectively. For comparison and clarity purpose, the CD curves of the Au—Ag, Au—Ag₂S and Au—CdS NRs are shifted vertically by 140, 250 and 400, respectively, while the extinction curves of the Au—Ag, Au—Ag₂S and Au—CdS NRs are shifted vertically by 0.85, 1.6 and 2.5, respectively.

FIG. 17 shows the experimental g-factor spectra of chiral Au NCs before and after phase transfer from aqueous phase to oil phase (toluene). The change of environmental dielectric constant leads to the wavelength shifting. The preservation of CD of chiral Au NCs after phase transfer demonstrates the stability and robustness of geometrical chirality induced by the imbalanced chiral facets on the surface of metal nanostructures, thus highlighting broad applications of this new type of chiral metal nanostructures under various chemical conditions.

### DETAILED DESCRIPTION

The present disclosure provides a novel family of chiral metal nanomaterials and their enabled chiral hybrid nanostructures with various dimensions (e.g., 5 to 200 nm) and morphologies (e.g. nanocubes and nanorods), characterized by imbalanced chiral facets on their surface which induce chirality. These chiral metal nanostructures can be synthesized using solution phase methods and exhibit intrinsic structural chirality with robustness, making them suitable for a wide range of chemical processing, phase transfer and practical applications. The present disclosure also provides a general synthetic strategy of such chiral metal nanostructures, utilizing chiral Au nanocubes and nanorods as exemplary embodiments of the new chiral metal nanostructures. Precise control over the structural chirality of these Au nanocubes and nanorods can be achieved by the present method, enabling thorough characterizations and understanding of their chiral properties. Furthermore, the present disclosure provides the utilization of the synthesized metal chiral nanostructures as cores for the growth of semiconductor and oxide shells, resulting in the formation of novel chiral hybrid metal-semiconductor nanostructures with preservation of chirality. Remarkably, the present chiral metal nanomaterials and methods represent a significant advancement in the field of chiral nanomaterials, offering new opportunities for the design and fabrication of functional materials and devices with tailored chirality for diverse applications in fields such as catalysis, drugs, sensing, photonics and biomedical engineering.

### Chiral Metal Nanomaterials

In one aspect, the present disclosure provides a chiral metal nanomaterial comprising a metal forming a nanostructure having controllable imbalanced chiral facets on the surface of the nanostructure.

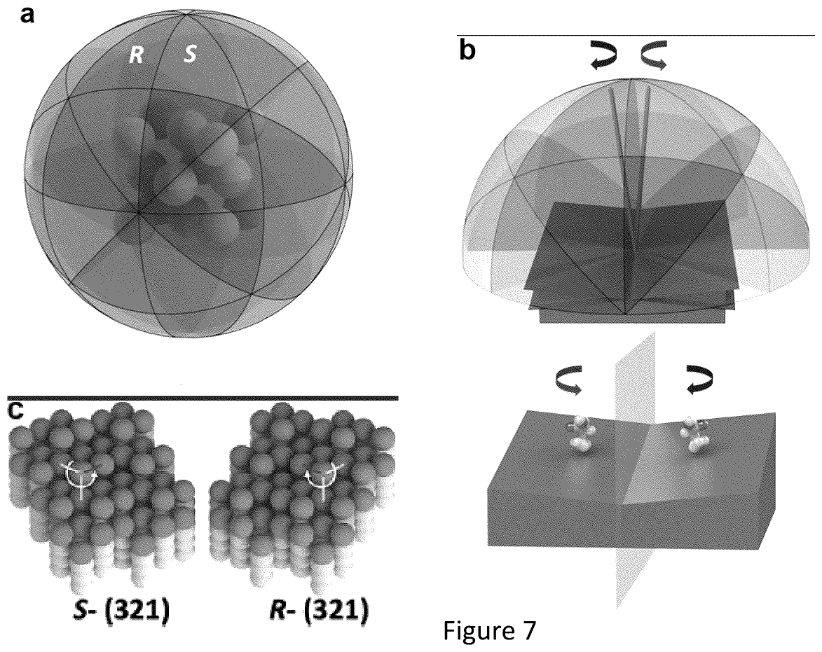

“Imbalanced chiral facets” refers to a chiral surface comprising of unequal distribution of left and right-handed high-Miller-index facets. Such chiral surface often has uneven structural features and can result in the appearance of chirality (or handedness) in an achiral inorganic crystal. The surface of an achiral nanostructure can be modeled as a mixture of low-Miller-index facets or a racemate of chiral high-Miller-index facets, such as a racemate of chiral R—and chiral S-facets. The chiral high-Miller-index facets exposed on the surface of the nanostructure may be controlled to achieve chirality. In some embodiments, the chirality may be generated by surface treatment using chiral organic molecules. The preferential occupancy of chiral molecules (e.g., L- or D-cysteine) onto specific chiral facets (e.g., R-facets for L-cysteine) inhibits their successive outward growth and thus leads to preferential growth of the chiral facets with opposite handedness. Therefore, the symmetry of the chiral high-Miller-index facet mixture is broken, leading to nanostructures with chiral surface morphology. In some embodiments, the chiral surface morphology comprises chiral boundary morphology. For example, the nanostructure may possess inhomogeneous or uneven structural features on the surface such as twisted boundary edges, concave or convex surfaces, and/or one or more protrusions on the surface. In contrast to the chiral nanostructures generated using alternative methods, the chiral nanostructures with imbalanced chiral facets disclosed herein are robust and maintain the same chiral morphology during harsh chemical conversions and phase transfer. FIG. 7 shows one exemplary notation of handedness induced by the chiral morphology of the nanostructure, using an fcc crystal lattice. However, the methods and compositions disclosed herein are general and can be applied to other crystallographic lattices.

The chiral high-Miller-index facets exposed on the surface of the nanostructure may be controlled to achieve chirality. In some embodiments, the control of the high-Miller-index facets may be achieved by tailoring the dimensions and/or the surface morphologies of these facets, which induces chirality of the nanostructure.

The controllable imbalanced chiral facets on the surfaces of the nanostructures as described herein can induce optical chirality of the nanostructure. As such, the chiral nanostructures may be characterized by their optical properties. It is noted that the chirality of the nanostructure may vary depending on their structural characteristics, such dimension, aspect ratio (AR), or surface morphology (e.g., surface protrusions). Therefore, optical properties may also vary between structurally distinct chiral nanostructures. In some embodiments, the chiral nanostructures are characterized using circular dichroism. In some such embodiments, the chiral nanostructures may display a bisignate spectra feature in circular dichroism (CD) measurements. For example, the chiral Au nanorods with 0-10 protrusions and/or an aspect ratio of 1-6 (such as 1.5-5) may display one or more peaks in the ±400 to 800 nm wavelength range.

The inhomogeneous features on the surface of the chiral nanostructures may also be recognized using spectroscopic techniques, such as scanning electron microscopy (SEM) and transmission electron microscopy (TEM). For example, SEM and TEM images of the chiral nanostructures may show twisted corners and/or twisted edges on the boundary, concave or convex surfaces, various dimensions, and/or one or more protrusions on the surface of the nanostructure.

In some embodiments, the metal is gold, platinum, cobalt, copper, nickel, silver, iron, palladium, aluminum, tin, lead, or alloys thereof. In some embodiments, the metal is gold.

The dimension of the nanostructure may vary and can be tailored. In some embodiments, the nanostructure has a dimension of about 5 nm to about 200 nm. The dimension of the nanostructure can be, for example, about 10 nm to about 180 nm, about 20 nm to about 160 nm, about 30 nm to about 140 nm, about 30 nm to about 120 nm, about 30 nm to about 100 nm, about 30 nm to about 90 nm, or about 30 nm to about 80 nm. In some embodiments, the dimension is about 20 nm, about 40 nm, about 60 nm, about 80 nm, about 100 nm, about 120 nm, about 140 nm, about 160 nm, or about 180 nm.

The origin of the optical chirality of the nanostructure disclosed herein may be general and applicable to nanostructures with various morphologies and/or shapes, including but not limited to, nanopolyhedrons and nanorods. In some embodiments, the nanostructure comprises nanocubes, nanorods, nanocuboctahedra, nanooctahedra, nano-triangular plates, nano-hexagonal plates, nanobars, nanodendrites, nano-bi pyramids, nanodecahedra, nano-icosahedrons, nanopolyhedrons, nanocages, nano-rhombic dodecahedra, nanotetrahedrons, nanobeams, or a combination thereof. In some embodiments, the chiral metal nanomaterial comprises gold nonocubes, gold nanorods, or a combination thereof.

In some embodiments, the nanostructure comprises nanocubes. The nanocubes may be of various morphologies, various shapes, and/or various sizes. In some embodiments, the nanostructure comprises nanocubes having a concave morphology, twisted edges on the boundaries, and/or an average size in the range of from about 20 nm to about 200 nm. For example, the nanocubes may have an average size of about 20 nm to about 200 nm, about 20 nm to about 180 nm, about 20 nm to about 160 nm, about 30 nm to about 140 nm, about 30 nm to about 120 nm, about 30 nm to about 100 nm, about 30 nm to about 90 nm, or about 30 nm to about 80 nm. In some embodiments, the nanocubes have an average size of about 50 nm. In some embodiments, the nanostructure comprises nanocubes having twisted corners.

In some other such embodiments, the nanostructure comprises nanorods. The nanorods may be of various morphologies, various shapes, and/or various sizes. In some embodiments, the nanostructure comprises nanorods having a concave morphology, twisted edges on the boundaries, 0-10 protrusions at the surface, and/or an aspect ratio of 1-6. For example, the nanorods may have 0-9 protrusions, 0-8 protrusions, 0-7 protrusions, or 0-6 protrusions at the surface. The nanorods may have an aspect ratio in the range of about 1.5 to about 5, about 1.5 to about 4, about 1.5 to about 3, or about 1.8 to about 2.5.

In some embodiments, the nanorods have a width of about 10 nm to about 100 nm. For example, the nanorods may have a width in the range of about 10 nm to about 90 nm, about 10 nm to about 80 nm, about 10 nm to about 70 nm, about 10 nm to 60 nm, about 10 nm to about 50 nm, about 10 nm to about 40 nm, or about 10 nm to about 30 nm. In some embodiments, the width is about 10 nm, about 20 nm, about 40 nm, about 60 nm, or about 80 nm. In some embodiments, the nanorods have a width of 18.3±0.5 nm.

In some embodiments, the chiral metal nanomaterials disclosed herein exhibit intrinsic structural chirality with robustness, making them suitable for a wide range of chemical processing, phase transfer and practical applications.

### Preparation Method

Disclosed herein are also methods for controlled synthesis of chiral metal nanomaterials. Chiral nanomaterials with intrinsic structural chirality can be generated with various morphologies, shapes, and sizes.

In another aspect, the present disclosure provides a method of preparing a chiral metal nanomaterial having controllable imbalanced chiral facets, comprising mixing a seed metal nanomaterial, a chiral organic compound, a surfactant, reducing agent, and a metal precursor to form a growth medium, whereby the chiral metal nanomaterial having controllable imbalanced chiral facets is produced.

“Metal precursor” refers to a precursor comprising the ion of the same metal as in the metal nanomaterial. Suitable metal precursors include, but are not limited to, HAuCl₄.

In some embodiments, the molar ratio of the seed metal nanomaterial to the chiral organic molecule is in the range of about 2000:1 to about 200:1. For example, the molar ratio of the seed metal nanomaterial to the chiral organic molecule may be about 1800:1 to about 200:1, about 1600:1 to about 200:1, about 1400:1 to about 200:1, about 1200:1 to about 200:1, about 1000:1 to about 400:1, or about 800:1 to about 600:1. In some embodiments, the molar ratio of the seed metal nanomaterial to the chiral organic molecule is in the range of about 800:1 to about 600:1. In some embodiments, the molar ratio of the seed metal nanomaterial to the chiral organic molecule is about 1200:1, about 1000:1, about 800:1, about 6:00:1, or about 400:1.

In some embodiments, the preparation method comprises:
mixing the seed metal material, the chiral organic compound, and the surfactant to form a first suspension;
generating a first precipitate from the first suspension;
resuspending the first precipitate to form a second suspension; and
adding the surfactant, the reducing agent, and the metal precursor to the second suspension to form the growth medium.

The substances used in the present method (e.g., surfactant, reducing agent, metal precursor) can be used as a solution, dispersion, or suspension in a solvent or liquid carrier. Solutions, dispersions, and suspensions as used herein, refer to a mixture in which one or more substances are dissolved, dispersed, or suspended (as would be generally understood in the art) in a solvent or liquid carrier. Suitable solvents or liquid carriers include, but are not limited to, water, organic solvents, or a combination thereof.

In some embodiments, the molar ratio of the seed metal material to the chiral organic compound in the first suspension is about 400:1 to about 1000:1, and the molar ratio of the surfactant to the chiral organic compound in the first suspension is about 64000:1 to about 160000:1. For example, in the first suspension, the molar ratio of the seed metal material to the chiral organic compound may be about 600:1 to about 1000:1, or about 600:1 to about 800:1; and the molar ratio of the surfactant to the chiral organic compound may be about 96000:1 to about 160000:1, or about 96000:1 to about 128000:1.

In some embodiments, the molar ratio of the surfactant to the metal precursor in the growth medium is from about 20:1 to about 2000:1; and the molar ratio of the reducing agent to the metal precursor in the growth medium is from about 1:1 to about 300:1. For example, in the growth medium, the molar ratio of the surfactant to the metal precursor may be about 100:1 to about 600:1 (such as about 200:1 to about 500:1); and the molar ratio of the reducing agent to the metal precursor may be about 5:1 to about 60:1 (such as about 10:1 to about 50:1).

In some embodiments, the method comprises:
mixing the surfactant, sodium borohydride (NaBH₄), and the metal precursor to form a third suspension;
adding the third suspension to a solution comprising the surfactant, silver nitrate, the reducing agent, and the metal precursor to form a fourth suspension;
generating a second precipitate from the fourth suspension;
resuspending the second precipitate to from a fifth suspension; and
adding the chiral organic molecule, the surfactant, the reducing agent, and the metal precursor to the fifth suspension to form the growth medium.

In some embodiments, the molar ratio of the surfactant:sodium borohydride (NaBH₄):the metal precursor in the third suspension is about 1000:6:2 to about 1000:6:3. For example, the molar ratio of the surfactant:sodium borohydride (NaBH₄):the metal precursor in the third suspension may be about 1000:6:2.5.

In some embodiments, the molar ratio of the surfactant:silver nitrate:the reducing agent:the metal precursor in the fourth suspension is about 1000:0.1:7:5 to about 1000:1:7:5. For example, the molar ratio of the surfactant:silver nitrate:the reducing agent:the metal precursor in the fourth suspension may be about 1000:0.4:7:5.

In some embodiments, the molar ratio of the surfactant to the metal precursor in the growth medium is about 150:1 to about 5000:1; and the molar ratio of the reducing agent to the metal precursor in the growth medium is from about 30:1 to about 600:1. For example, the molar ratio of the surfactant to the metal precursor may be about 1000:1 to about 4000:1, and the molar ratio of the reducing agent to the metal precursor may be from about 50:1 to about 300:1. In some embodiments, the molar ratio of the surfactant:the reducing agent:the metal precursor in the growth medium is about 1050:130:1 (e.g., 3200:400:3).

In some embodiments, the method further comprises isolating the chiral metal nanomaterial by precipitation. The chiral metal nanomaterial produced by the above procedure may be referred to as the first chiral metal nanomaterial.

In some embodiments, the first chiral metal nanomaterial collected may be further subjected to one or more overgrowth processes, during which control and tailoring of their dimensions and/or morphologies on the imbalanced chiral facets may be achieved, therefore realizing chirality control of the overgrown products. The inhomogeneous features on the surface of the chiral overgrown products may be characterized using CD measurements and/or spectroscopic techniques, such as SEM, and/or TEM.

In some such embodiments, the method further comprises:
resuspending the chiral metal nanomaterial to form a sixth suspension;
adding the reducing agent and the metal precursor to the sixth suspension; and
allowing the sixth suspension to sit to form an overgrown chiral metal nanomaterial.

The overgrown chiral metal nanomaterial produced by the above procedure may be referred to as the second chiral metal nanomaterial.

In some such embodiments, the chiral metal nanomaterial and the overgrown chiral metal nanomaterial have different aspect ratios in the range of 1.5-5 and/or different numbers of protrusions in the range of 0-10. For example, the chiral metal nanomaterial and the overgrown chiral metal nanomaterial may have different aspect ratios in the range of 1.5-4, 2-5, or 2-4. The chiral metal nanomaterial and the overgrown chiral metal nanomaterial may have different numbers of protrusions in the range of 0-9, 0-8, 0, 7, or 0-6.

In some embodiments, the precipitates are generated by centrifugation.

The methods disclosed herein may be general and applicable to various metals to induce imbalanced chiral facets on the surface of the nanomaterial, leading to the first chiral metal nanomaterial and/or the overgrown/second chiral metal nanomaterial. In some embodiments, the metal is gold, platinum, cobalt, copper, nickel, silver, iron, palladium, aluminum, tin, lead, or alloys thereof. In some embodiments, the metal is gold.

The methods disclosed herein may be general and applicable to seed metal nanomaterials with various morphologies and/or shapes, including but not limited to, nanopolyhedrons and nanorods. Seed metal nanomaterials containing various types of crystallographic lattices may be utilized. In some embodiments, the seed metal nanostructure comprises nanocubes, nanorods, nanocuboctahedra, nanooctahedra, nano-triangular plates, nano-hexagonal plates, nanobars, nanodendrites, nano-bi pyramids, nanodecahedra, nano-icosahedrons, nanopolyhedrons, nanocages, nano-rhombic dodecahedra, nanotetrahedrons, nanobeams, or a combination thereof. In some embodiments, the seed metal nanostructure can be modeled as a racemate of chiral high-Miller index facets. In some embodiments, the seed metal nanostructure comprises an achiral fcc lattice.

In some embodiments, the surfactant comprises C₁₀₋₂₀alkyltrimethylammonium bromides or C₁₀₋₂₀alkyltrimethylammonium chloride. In some such embodiments, the surfactant comprises cetyltrimethylammonium chloride (CTAC) or cetyltrimethylammonium bromide (CTAB).

A strong reducing agent may be used for making the metal seeds. Suitable strong reducing agents include, but are not limited to, sodium borohydride. A mild reducing agent may be utilized during the growth of the chiral metal nanomaterials. Suitable mild reducing agents include, but are not limited to, ascorbic acid. In some embodiments, the reducing agent comprises ascorbic acid, sodium borohydride (NaBH₄), or a combination thereof.

Metal precursors comprising the ion of the same metal as in the metal nanomaterial may be used. In some embodiments, the metal precursor comprises HAuCl₄. Different compounds comprising metal ions can be used as the metal precursor.

In some embodiments, the chiral organic compound comprises a small molecule. In some embodiments, the chiral organic compound comprises an amino acid. For example, the amino acid can be L-cysteine, D-cysteine, L-glutathione, or D-gluathione.

The present preparation method can be used to produce the chiral metal nanomaterial as described herein. Precise control over the structural chirality of these nanomaterials can be achieved, enabling thorough characterization and understanding of their chiral properties.

In another aspect, the present disclosure provides a chiral metal nanomaterial produced by the method as described herein.

The chiral metal nanomaterial may be of various morphologies, various shapes, and/or various sizes and dimensions, including but not limited to, nanopolyhedrons and nanorods. In some embodiments, the chiral metal nanomaterial comprises nanocubes, nanorods, nanocuboctahedra, nanooctahedra, nano-triangular plates, nano-hexagonal plates, nanobars, nanodendrites, nano-bi pyramids, nanodecahedra, nano-icosahedrons, nanopolyhedrons, nanocages, nano-rhombic dodecahedra, nanotetrahedrons, nanobeams, or a combination thereof. In some embodiments, the chiral metal nanomaterial comprises nanocubes, nanorods, or a combination thereof.

In some embodiments, the chiral metal nanomaterial comprises chiral nanocubes having a concave morphology, an average size of about 20 nm to about 200 nm (such as 50 nm, 100 nm, or 150 nm) and/or twisted corners. The twisted corners can originate, for example, from chiral high Miller index facets. In some embodiments, the chiral metal nanomaterial comprises chiral nanorods having a concave morphology, 0-10 protrusions at the surface, and/or an aspect ratio of about 1.5-5 (such as 1.5-4). Higher number of protrusions (such as 15 or 20 protrusions) and higher aspect ratio (such as about 6, about 8, about 10, or about 12) can also be achieved. For example, the chiral nanorods may have 0-9 protrusions, 0-8 protrusions, 0-7 protrusions, or 0-6 protrusions at the surface. The nanorods may have an aspect ratio in the range of about 1.8-3.2.

The optical properties and morphologies of the chiral metal nanomaterials prepared by the methods disclosed herein may be characterized using the techniques disclosed herein.

The chiral metal nanostructures with imbalanced chiral facets prepared by the present methods may not require chiral molecules in the nanostructure once the nanostructure is created. For example, the produced nanostructure can be transferred from an aqueous phase to an organic phase (e.g., toluene) with achiral molecules for passivation.

In some embodiments, the chiral metal nanomaterial produced by the present methods further includes a chiral organic molecule.

### Hybrid Chiral Metal-Semiconductor Nanostructures

The chiral metal nanomaterials disclosed herein can be used as building blocks toward the formation of complex chiral nanostructures, such as by integrating with additional components including semiconductor and oxide shells. Novel chiral hybrid materials such as metal-semiconductor nanostructures can be achieved with preservation of the chirality.

In another aspect, the present disclosure provides a method of producing a chiral hybrid nanomaterial comprising semiconductor, the method comprising:
(a) mixing a chiral metal nanomaterial with a silver salt, a surfactant, and a reducing agent in a first medium, thereby producing an intermediate hybrid nanomaterial comprising silver, wherein the chiral metal nanomaterial comprises a metal forming a nanostructure having controllable imbalanced chiral facets on the surface of the nanostructure; and
(b) mixing the intermediate nanomaterial with an anion X in a second medium, thereby producing a first chiral hybrid nanomaterial comprising Ag—X semiconductor.

The chiral metal nanomaterial can be the same chiral metal nanomaterial described herein or the same chiral metal nanomaterial produced by the preparation method as described herein. The chiral hybrid nanomaterial can comprise a chiral metal core that possesses unique imbalanced chiral facets on its surface and semiconductor shell. The intermediate hybrid nanomaterial comprising silver can include, for example, a silver shell.

In some embodiments, the method further comprises:
(c) mixing the first chiral hybrid nanomaterial comprising Ag—X semiconductor and a cation M′ in a third medium, thereby producing a second chiral hybrid nanomaterial comprising M′-X semiconductor.

In some embodiments, the third medium comprises R₃P. In some such embodiments, R is C1-10 alkyl. For example, R₃P may be (CH₃CH₂CH₂CH₂)₃P.

In some embodiments, silver salt is silver nitrate.

In some embodiments, X is O²⁻, S²⁻, Se²⁻, or Te²⁻, or a combination thereof. The Ag—X semiconductor can comprise, for example, Ag₂X. In some embodiments, X is S²⁻ and the Ag—X semiconductor is Ag₂S. In some embodiments, M′ is Cu⁺, Au⁺, Cd²⁺, Zn²⁺, Mn²⁺, Fe²⁺, Co²⁺, Al³⁺, Ag⁺, Sn²⁺, Ni⁺, Pt⁺, Pd⁺, or Pb²⁺, or a combination thereof. In some such embodiments, the M′-X semiconductor is CdS.

In some embodiments, the Ag—X semiconductor is Ag₂S, Ag₂Se, or Ag₂Te. In some embodiments, the M′-X semiconductor is CdS, CdSe, or CdTe.

In some embodiments, the first medium has a pH in range of about 8 to about 11. For example, the first medium may have a pH in range of about 9 to about 11. In some embodiments, the first medium has a pH of about 10.

In some embodiments, the surfactant for the chiral hybrid nanomaterial preparation method comprises C₁₀₋₂₀alkyltrimethylammonium bromides or C₁₀₋₂₀alkyltrimethylammonium chloride. In some embodiments, the surfactant comprises cetyltrimethylammonium chloride (CTAC) or cetyltrimethylammonium bromide (CTAB).

In some embodiments, the molar ratio of the chiral metal nanomaterial to the silver salt in the first medium is about 5:1 to about 1:5. For example, the molar ratio of the chiral metal nanomaterial to the silver salt in the first medium may be about 4:1 to about 1:4, about 3:1 to about 1:3, or about 2:1 to about 1:2. In some embodiments, the molar ratio of the chiral metal nanomaterial to the silver salt in the first medium is about 1:1.

In some embodiments, the molar ratio of the surfactant to the reducing agent in the first medium is about 10:1 to about 100:1. For example, the molar ratio of the surfactant to the reducing agent in the first medium may be about 10:1 to about 90:1, about 10:1 to about 80:1, about 10:1 to about 70:1, about 20:1 to about 60:1, or about 30:1 to about 50:1. In some embodiments, the molar ratio of the surfactant to the reducing agent in the first medium is about 40:1.

In some embodiments, the molar ratio of the intermediate nanomaterial to the anion X in the second medium is about 1:20 to about 1:100. For example, the molar ratio of the intermediate nanomaterial to the anion X in the second medium may be about 1:20 to about 1:90, about 1:30 to about 1:80, about 1:40 to about 1:70, or about 1:40 to about 1:60. In some embodiments, the molar ratio of the intermediate nanomaterial to the anion X in the second medium is about 1:50.

In some embodiments, the molar ratio of the first chiral hybrid nanomaterial comprising Ag—X semiconductor to the cation M′ in the third medium is from about 1:5 to about 1:50. For example, the molar ratio of the first chiral hybrid nanomaterial comprising Ag—X semiconductor to the cation M′ in the third medium may be about 1:5 to about 1:40, about 1:5 to about 1:30, or about 1:5 to about 1:20. In some embodiments, the molar ratio of the first chiral hybrid nanomaterial comprising Ag—X semiconductor to the cation M′ in the third medium is about 1:10.

In some embodiments, the temperature of the third medium is in the range of about 50° C. to about 70° C. In some embodiments, the temperature of the third medium is about 60° C.

In another aspect, the present disclosure provides a chiral hybrid nanomaterial comprising semiconductor produced by the methods disclosed herein. The chiral morphology of the chiral metal nanomaterial used to prepare the hybrid nanomaterial remains the same, highlighting the robustness of the chiral nanomaterial prepared by the methods disclosed above.

Unless defined otherwise, all technical and scientific terms used herein have the same meaning as commonly understood by one of ordinary skill in the art to which the invention pertains. All definitions, as defined and used herein, should be understood to control over dictionary definitions, definitions in documents incorporated by reference, and/or ordinary meanings of the defined terms. As used herein, the terms “have,” “has,” “having,” “include” and “including” have the same meaning as the terms “comprise” and “comprising.” The terms “comprise” and “comprising” should be interpreted as being “open” transitional terms that permit the inclusion of additional components further to those components recited in the claims. The terms “consist” and “consisting of” should be interpreted as being “closed” transitional terms that do not permit the inclusion of additional components other than the components recited in the claims. The term “consisting essentially of” should be interpreted to be partially closed and allowing the inclusion only of additional components that do not fundamentally alter the nature of the claimed subject matter. As used herein, the singular forms “a,” “an,” and “the” include plural embodiments unless the context clearly dictates otherwise. The modifier “about” used in connection with a quantity is inclusive of the stated value and has the meaning dictated by the context (for example, it includes at least the degree of error associated with the measurement of the particular quantity). The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9 to 1.1.

All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention. All references, including publications, patent applications, and patents, cited herein are hereby incorporated by reference.

The present invention has been described in terms of one or more embodiments, and it should be appreciated that all possible equivalents, alternatives, variations, and modifications, aside from those expressly stated are within the scope of the invention.

### EXAMPLES

### Example 1

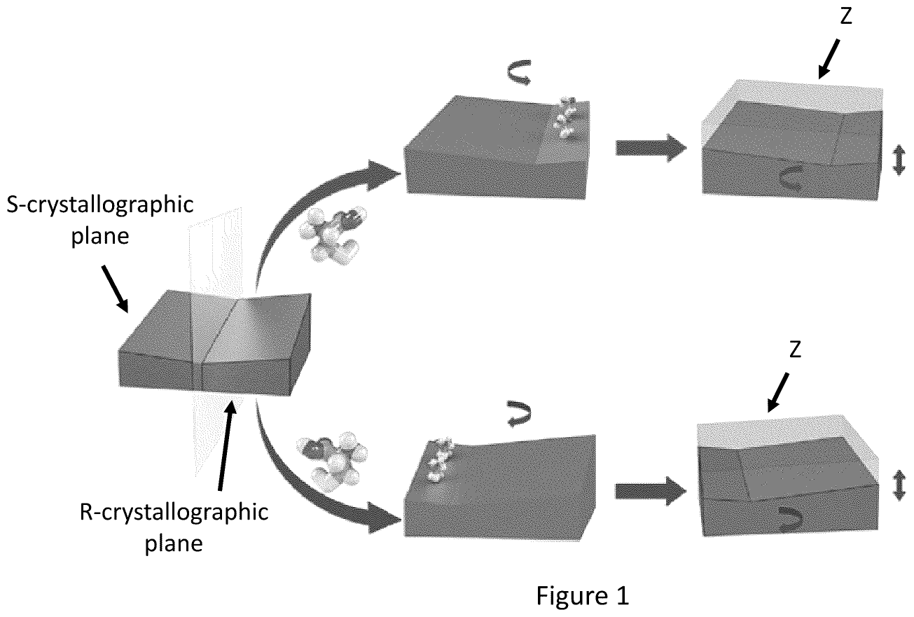

FIG. 1 shows schematics of how to employ small organic chiral molecules to preferentially occupy enantioselective chiral facets during the synthesis of achiral inorganic nanostructures. This enantioselective interaction leads to a biased kinetic growth rate favoring crystallographic overgrowth with opposite handedness, thus dictating the prevailing coverage of one handedness of chiral facets on the surface to induce the robust chiral boundary morphology of an inorganic nanostructure. One significance of such chiral inorganic nanostructures is to serve as building blocks to allow the creation of novel chiral hybrid nanostructures through interfacial epitaxial and non-epitaxial growth to form various chirality coupling at the nanoscale. Au nanostructures was chosen as an example to demonstrate the proposed strategy in FIG. 1 based on a few considerations: First, the Au possesses an achiral fcc lattice and synthesis of achiral Au nanostructures with versatile controls have been achieved, which make Au an excellent testbed for understanding the role of chiral morphology in an achiral crystal. It is worth noting that a gigantic chiral Au structure with a size of a few hundred nanometers have been achieved recently; however, small-sized chiral Au nano-crystals with robust chirality that can be potentially utilized as chiral functional building blocks have been absent, which is the impetus of the current work. Second, Au nanostructures have been demonstrated to possess strong localized surface plasmon resonance (LSPR), which is uniquely determined by the size and morphology of nanostructures. Therefore, the chirality of crystalline boundary morphology should have a direct implication in LSPR due to the delocalization of plasmonic electrons, which plays an important role in the emerging field of chiral plasmonics and in understanding the interplay between chirality and plasmonics. Last but not the least, it has been demonstrated that functional hybrid nanostructures comprising or consisting of metal and semiconductor subunits can be synthesized by a nonepitaxial approach with enhanced and tunable light-matter coupling. Consequently, if the standalone chiral Au nanostructures can be achieved with robust chirality, chirality of metal subunits might be imprinted to semiconductor subunits to create unique chiral hybrid nanostructures with exotic functionality and properties. In following the proposed synthetic strategy outlined in FIG. 1, Au nanostructures with well-defined achiral morphology (e.g., nanocubes, NCs or nanorods, NRs) was used as seeds, followed by surface treatment with chiral molecules (e.g., L-/D-cysteine). After the removal of excessive chiral molecules from the surface treatment, overgrowth of chiral Au nanostructures is initiated and kinetically controlled by a slow injection of an Au precursor with a mild reducing agent such as ascorbic acid. The notation of the handedness of as-synthesized chiral Au nanostructures is described in the Supporting Information.

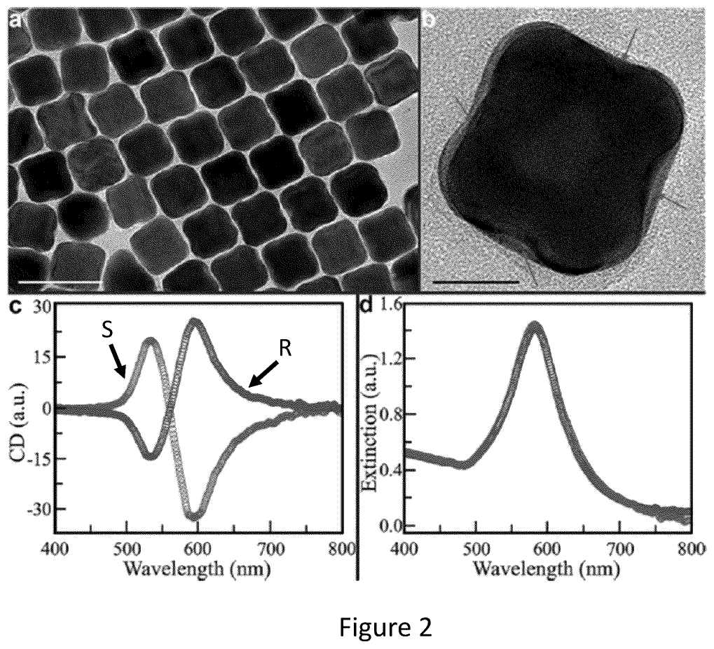

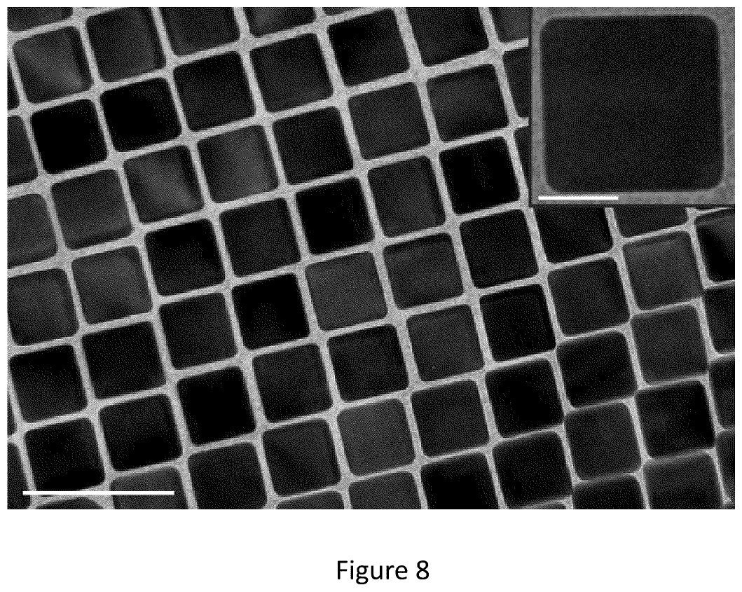

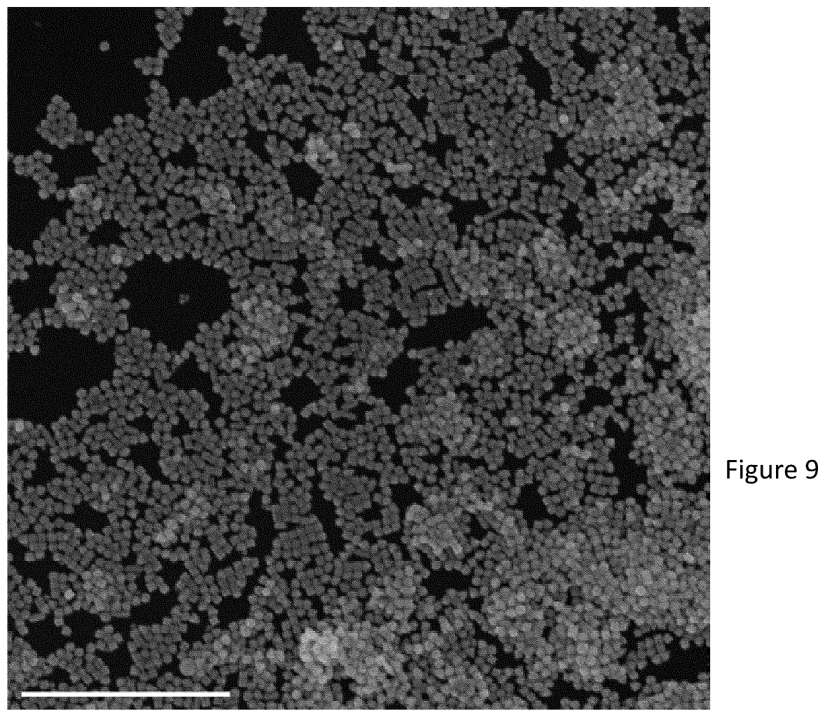

Chiral Au Nanocubes. FIG. 2, panel a shows a typical transmission electron microscopy (TEM) image of chiral S—Au NCs with an average size of 50 nm by using L-cysteine molecules, which were grown from achiral seed NCs shown in FIG. 8. A large-scale scanning electron microscopy (SEM) image is presented in FIG. 9 to highlight the yield of as-synthesized chiral Au NCs without any postprocessing of samples. Different from achiral Au NCs possessing uniform morphology with a flat surface, the high-resolution TEM image of a single chiral NC as presented in FIG. 2, panel b shows inhomogeneous identities on the surface with a few highlighted by red arrows. Importantly, the circular dichroism (CD) measurement of as-synthesized S—Au chiral NCs in FIG. 2, panel a shows the presence of a clear bisignate spectra feature (red data points in FIG. 2, panel c), i.e., a positive peak at 532 nm and a negative peak at 592 nm. For the chiral R—Au NCs that are synthesized by using D-cysteine molecules, while other synthetic conditions remain the same, their corresponding CD spectrum is also presented in FIG. 2, panel c (blue data points) for comparison, in which the CD peaks occur at the same wavelengths but with opposite sign. For both chiral R—and S—Au NCs, their optical extinction spectra are almost identical (FIG. 2, panel d), similar to the case of molecular enantiomers.

A few mechanisms have been proposed to account for chiral plasmonic nanoparticles, including electromagnetic interaction between chiral molecules and plasmonic resonance on the surface and formation of chiral oligomers. A control experiment was performed by passivating the surface of achiral Au NCs with chiral molecules but without overgrowth; however, no detectable CD is found from such samples. This is also consistent with the analysis that for the high symmetric plasmonic nanostructure like nanospheres or NCs, the chirality induced by electromagnetic coupling between embedded/coated chiral molecules and nanostructures could be canceled out, and the effect of chiral molecules in this scenario is negligible. Furthermore, although chiral-template-mediated interparticle interactions in a plasmonic oligomer has been observed in literatures, such chiral oligomers have been absent in the current analysis based on TEM and SEM characterizations, and the concentration of chiral molecules utilized in the chiral synthesis is much smaller than that required for the formation of chiral oligomers.

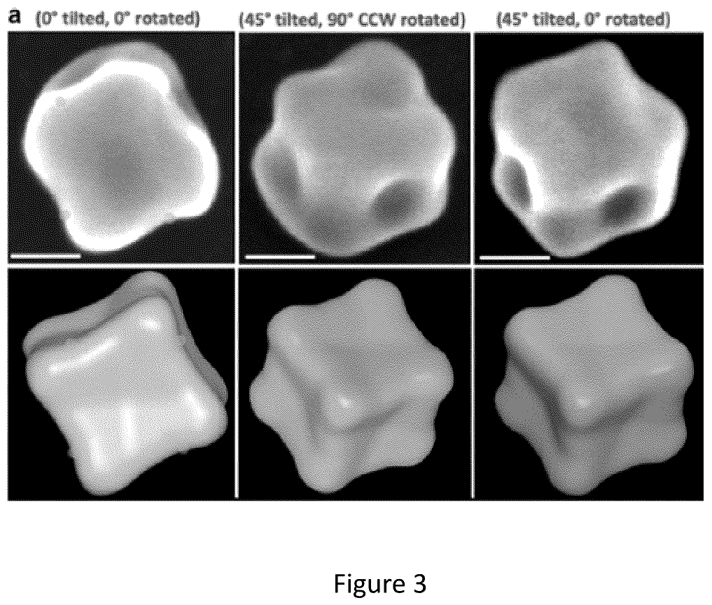

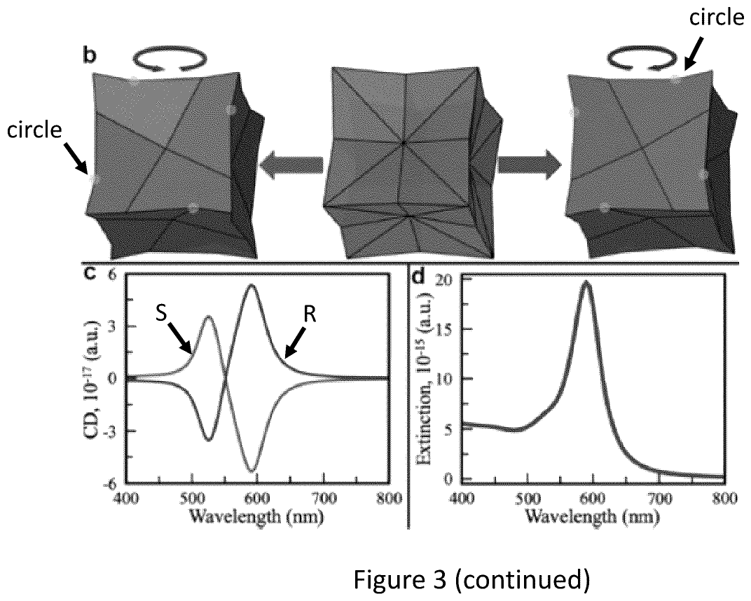

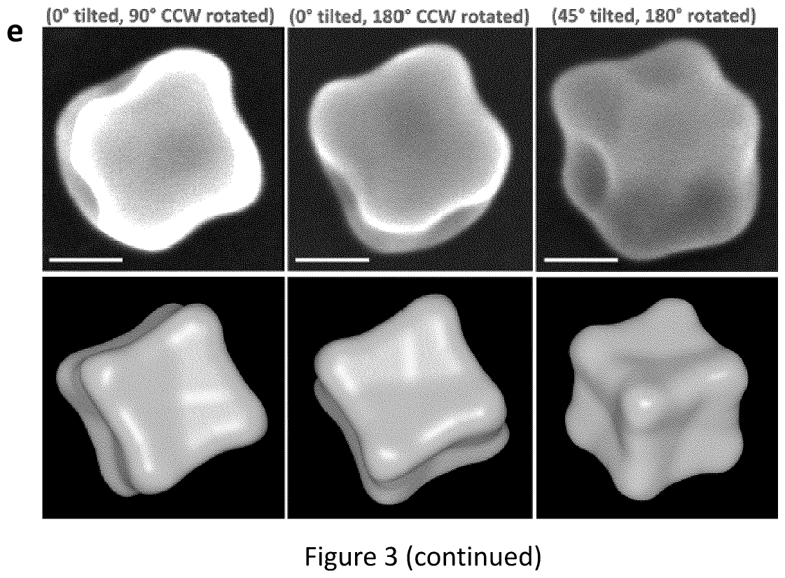

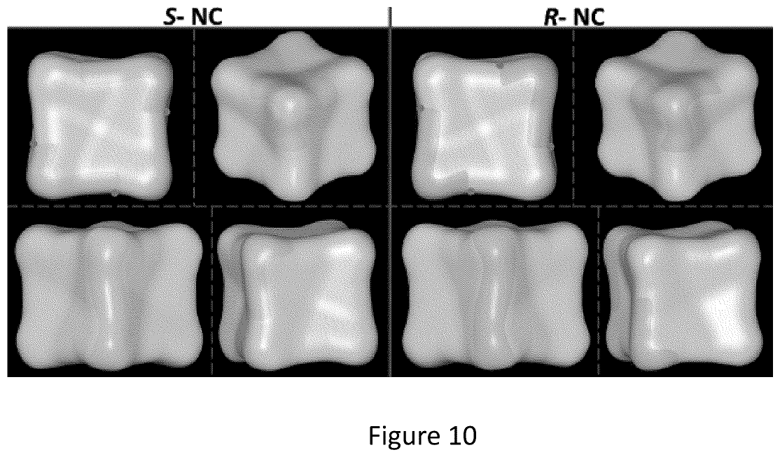

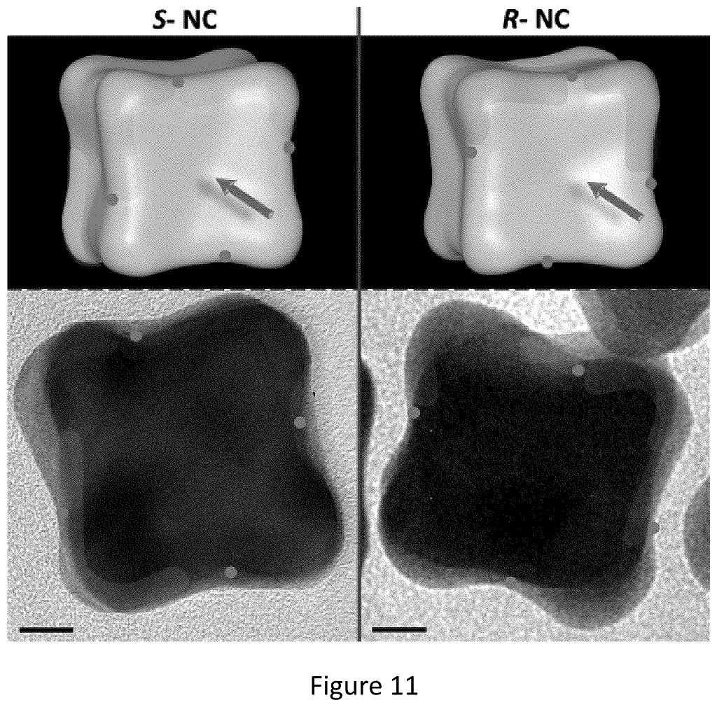

In order to understand the inhomogeneous morphological features as highlighted in FIG. 2, panels a, b and to elucidate the origin of their optical characteristics shown in FIG. 2, panels c, d, a thorough angle-dependent high-resolution SEM characterization of single S—Au NC was performed with three examples presented in FIG. 3, panels a and c. A few structural features can be immediately identified: First, although the overall shape of a chiral Au NC remains cubic, its surface becomes concave after the overgrowth, which is consistent with TEM observation in FIG. 2, panel b and can be attributed to the edge- and corner-favored growth under the kinetically controlled condition. The fact of the formation of concave surfaces further suggests the exposure of high-Miller-index facets during the growth. Second, the boundary edges of chiral Au NCs are twisted as is evident from the twisting sites highlighted by the four small green circles in FIG. 3, panel a. From the crystallographic viewpoint (FIGS. 7 and 1), the surface of a regular achiral concave Au NC can be modeled as a racemate of chiral high-Miller-index facets, which is schematically shown in the middle of FIG. 3, panel b. In the presence of chiral molecules like L-cysteine, the preferential occupancy of chiral molecules onto specific chiral facets (e.g., R-facets for L-cysteine) inhibits their successive outward growth and thus leads to preferential kinetic growth of chiral facets with opposite handedness. As a result, the predominant coverage of chiral facets with exclusive handedness is achieved on the surface of a chiral NC, resulting in chiral morphology with a feature of twisting boundary edges, as schematically shown in FIG. 3, panel b. The small green filled circles on both the right and left NCs in FIG. 3, panel b highlight the twisting sites on the edge, which are formed by simply considering the prevailing overgrowth of one type of chiral facets from a concave surface. Based on the proposed mechanism illustrated in FIG. 3, panel b, a structural model was constructed and compared it with SEM images acquired at the different tilting and rotating angles (FIG. 3, panel a), which shows excellent agreement with experimental results and can elucidate chiral characteristics of morphology as manifested in the SEM characterization. It is worth noting that, due to their small size, direct structural differentiation between two different handedness, S—and R—Au NCs can become subtle. However, the twisting boundary edges observed in FIG. 3 can often offer a useful means to discriminate two different handedness by the electron microscopy imaging (FIG. 10), with one example presented in FIG. 11 to compare images of S—and R—Au NCs. More importantly, the constructed models presented in FIG. 3, panel a was utilized to compute optical properties of chiral Au NCs by using finite element method (FEM) simulation and presented both theoretical CD and extinction spectra in FIG. 3, panels c, d, which also shows excellent agreement with experimental data in FIG. 2, panels c, d. This offers a sanity check of the model and assignment and supports the proposed CD mechanism of as-synthesized chiral Au NCs. Furthermore, it is remarkable that the as-synthesized chiral Au NCs represent a different chiral entity from the existing works beyond just size difference. For example, the chiral Au NCs possess concave morphology, while a more complex convex-like shape has been demonstrated in much larger chiral cubic Au structures. This can be attributed to different growth kinetics of chiral Au NCs. Additionally, although same chiral molecules (L-cysteine) were employed to induce chirality in the gigantic Au NCs, the R-facets were found to exist on their surfaces and contribute to the handedness, while the chiral S-facets are the dominant chiral high-Miller-index facets in the current work. A thorough understanding of how chiral organic molecules play a role in the growth of inorganic chiral nanostructures at the different length scale and different growth conditions/dynamics will require more substantial work and should offer invaluable insights and controls to engineer inorganic chirality.

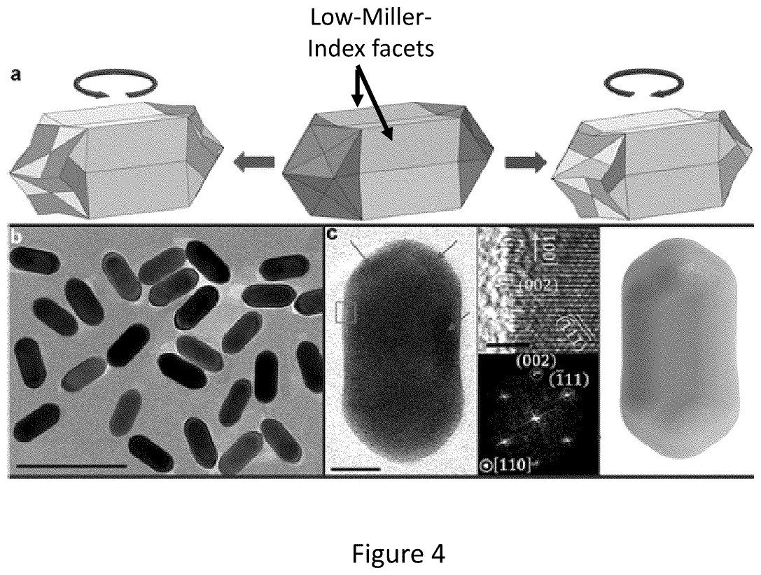

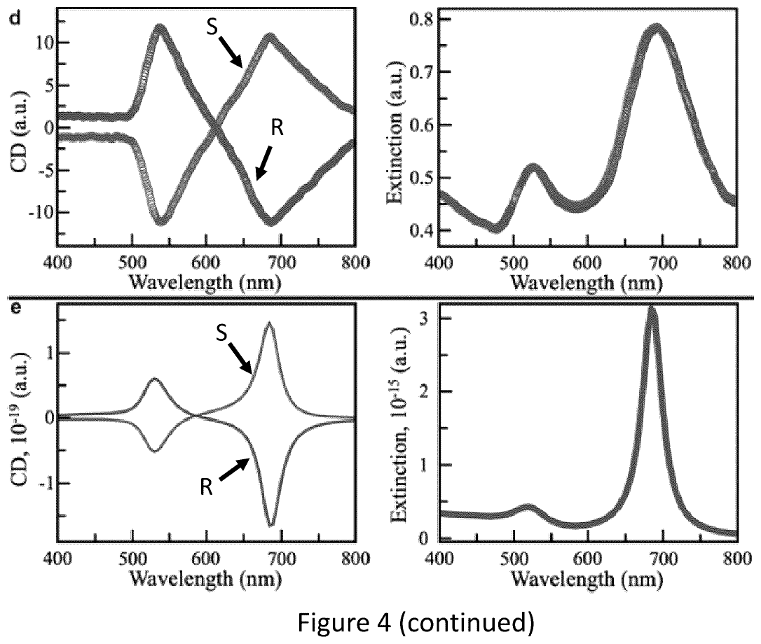

Chiral Au Nanorods. Notably, the present model and understanding of the CD origin in chiral Au NCs, which is based on the symmetry breaking of chiral high-Miller-index facets on the surface, is general and can be immediately applied to other nanostructures to induce and control similar extrinsic handedness. FIG. 4 presents another example of chiral Au NRs by following a similar mechanism and growth process. As compared with Au NCs, Au NRs are more complicated from the structural viewpoint but possess more tunability to engineer their properties and functionalities. For example, a few structural parameters including the aspect ratio (AR) and the surface facets on both sides and ends of an NR often play a crucial role in determining various physical and chemical properties and functionalities.

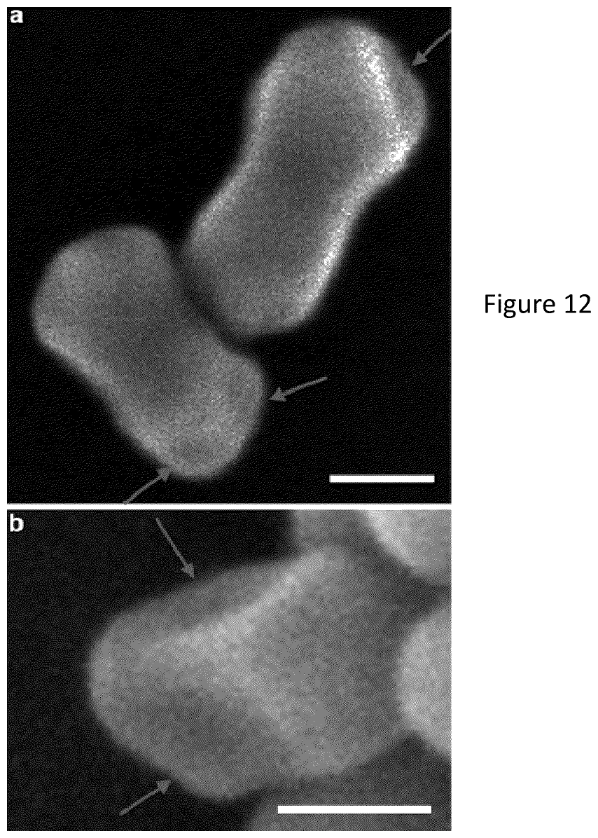

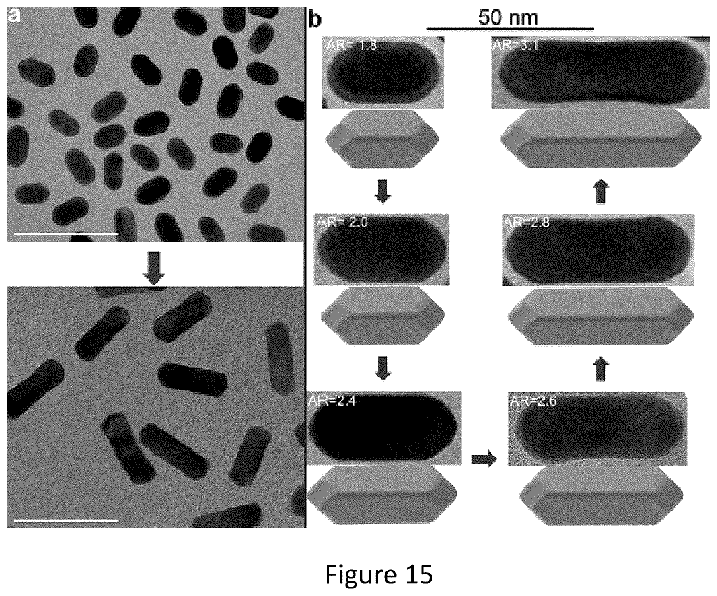

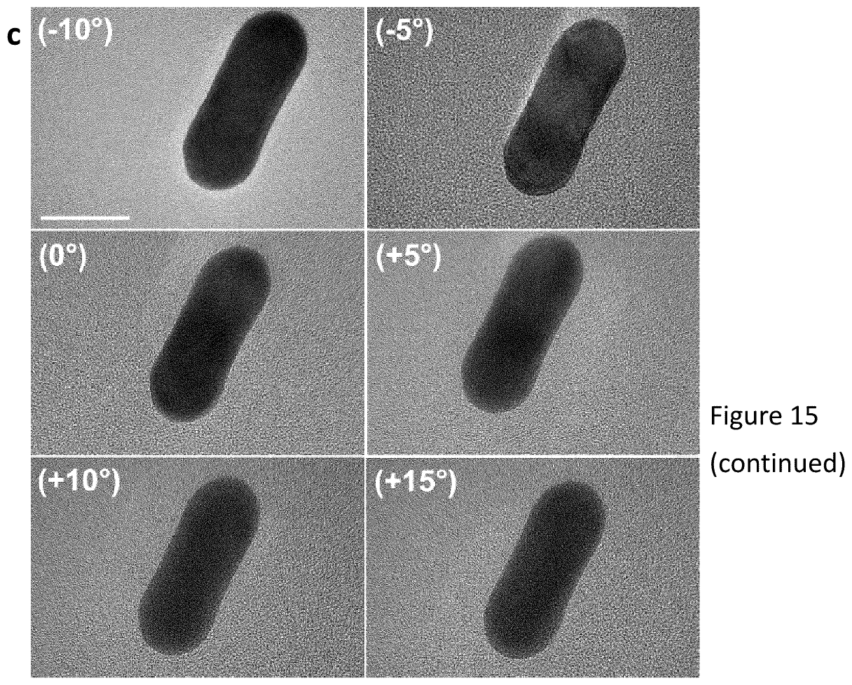

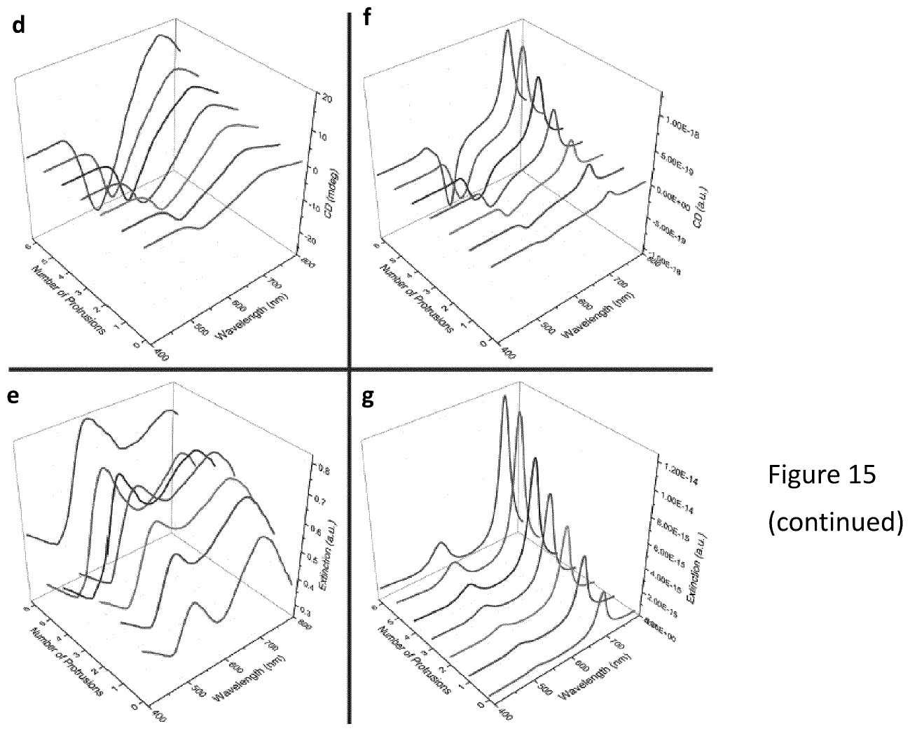

Achiral Au NRs that are synthesized by using the well-known seed-mediated growth method were chosen as the starting structures and then overgrowth was performed after treatment using chiral molecules to control the handedness of overgrown Au NRs. Typically, a regular achiral NR can be modeled as a four-sided elongated rhombic dodecahedron (middle in FIG. 4, panel a), whose side surfaces manifest achiral low-index facets (110), while the high surface curvature at the apexes often makes chiral high-Miller-index facets (red and blue regions) more accessible at both ends. This can provide an invaluable opportunity to induce intriguing chirality of NRs by controlling the prevalence of chiral high-Miller-index facets at the end of NRs, as schematically shown in FIG. 4, panel a. FIG. 4, panel b shows one typical TEM image of overgrown chiral Au NRs assisted by the chiral L-cysteine molecules in the growth. Both high-resolution TEM (FIG. 4, panel c) and SEM characterizations (FIG. 12) have confirmed that the as-synthesized chiral Au NR remains an overall four-sided elongated rhombic dodecahedron but with concave morphology in the boundary facets. The atomic image and its fast Fourier transform (FFT) pattern show the undistorted (110) facets on the sides, which is evident by a typical FFT pattern along the Au [110] direction and indexing the (111) and (002) planes in FIG. 4, panel c. The concave morphology can be clearly observed at both ends of NRs that is similar to the concave characteristics and chiral high-Miller-index facets of chiral NCs in FIGS. 2 and 3. Furthermore, angle-dependent TEM characterization of single chiral NR was performed, confirming straight and undistorted sides (FIG. 15, panel c).

It was found that the as-synthesized chiral Au NRs manifest CD features in the visible regime. In particular, FIG. 4, panel d (red data points) shows experimental CD (left) and extinction (right) spectra of the S—Au NRs from FIG. 4, panel b, which is grown by using L-cysteine molecules. For comparison, the optical data acquired from the R—Au NRs that possess the same dimensions but were grown using D-cysteine instead are also presented (blue data points). Both R- and S-chiral Au NRs exhibit almost identical optical extinction features, and two absorption peaks at 525 and 660 nm can be attributed to the transverse and longitudinal LSPR modes of the Au NRs, respectively. Meanwhile, their CD spectra show the opposite signs with peaks at 530 and 660 nm.

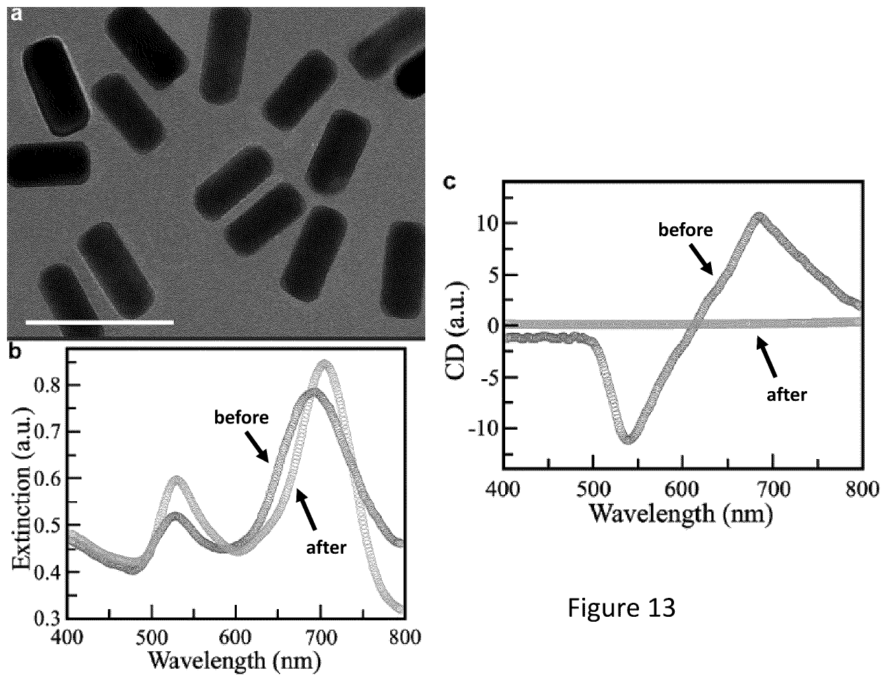

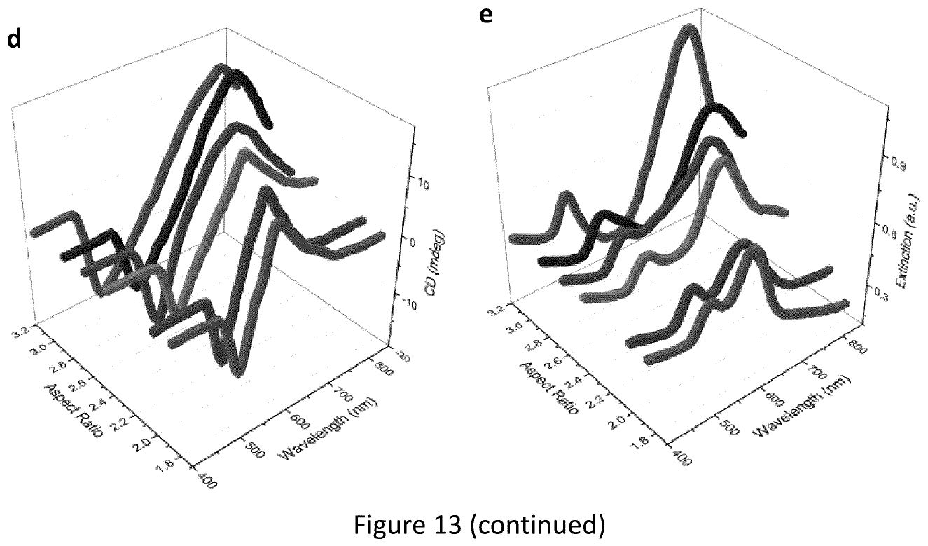

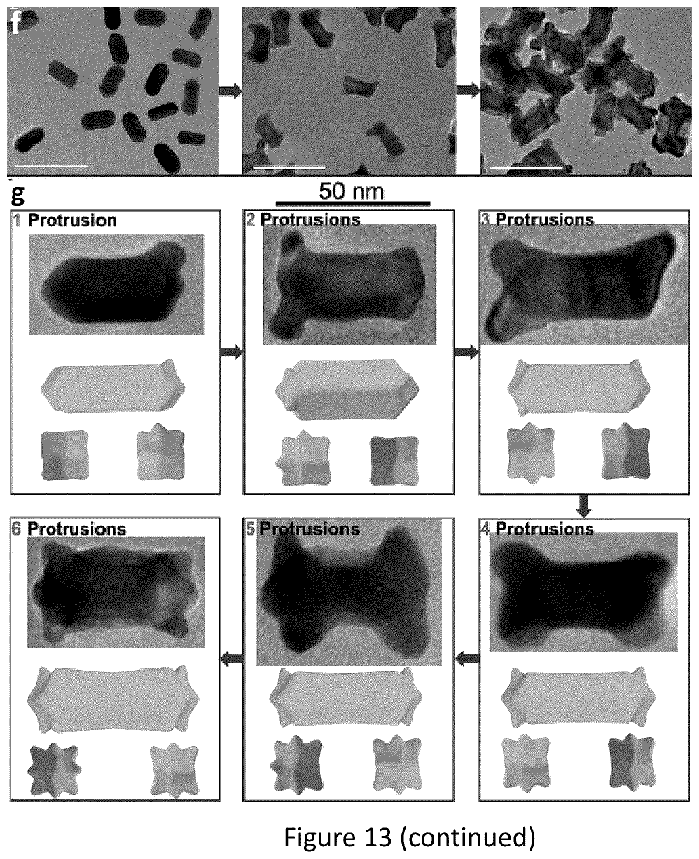

In order to elucidate the underlying mechanism of observed chirality in the Au NRs, two control experiments were performed. First, surface ligand molecules were removed after growth of chiral Au NRs by a ligand exchange process with achiral oleylamine molecules and redispersed the chiral Au NRs in toluene, and it was observed that the CD features remain almost unchanged. This observation excludes the role of possible residue chiral molecules on the surface. Second, chiral overgrowth conditions were modified and additional Au layers were coated onto chiral Au NRs by using a binary surfactant mixture of cetyltrimethylammonium chloride and sodium oleate (FIG. 13, panels a-c). This modified overgrowth condition led to an even morphology of NRs, and those inhomogeneous structural features that are originally observed from the chiral Au NRs disappear (FIG. 4, panel c and FIG. 12). Correspondingly, the CD features measured after this second overgrowth almost completely disappear. This control experiment unambiguously suggests that the observed CD in FIG. 4, panel d originates from the boundary morphology itself rather than other mechanisms. Similar to the CD mechanism observed in chiral Au NCs that is attributed to the existence of prevailing chiral high-Miller-index facets on the surface, it is proposed that the prevailing chiral high-Miller-index facets exist on both ends of the chiral Au NRs as schematically shown in FIG. 4, panel a. The exposure of chiral high-Miller-index facets at the ends of NRs originates from the kinetically controlled overgrowth reaction, and the adsorption of chiral molecules onto enantioselected chiral high-Miller-index facets breaks the symmetry and thus promotes the formation of each enantiomorph dependent upon the molecular chirality. Based on this proposed mechanism, a structural model of a chiral Au NR is constructed and presented in FIG. 4, panel c to compare with its corresponding TEM image, showing an excellent agreement. More importantly, the CD and extinction spectra were computed by using the structural model in FIG. 4, panel c and presented the results in FIG. 4, panel e. The excellent agreement between the experimental (FIG. 4, panel d) and simulation (FIG. 4, panel c) results has validated the proposed CD mechanism as well as the structural model in FIG. 4, panel c.

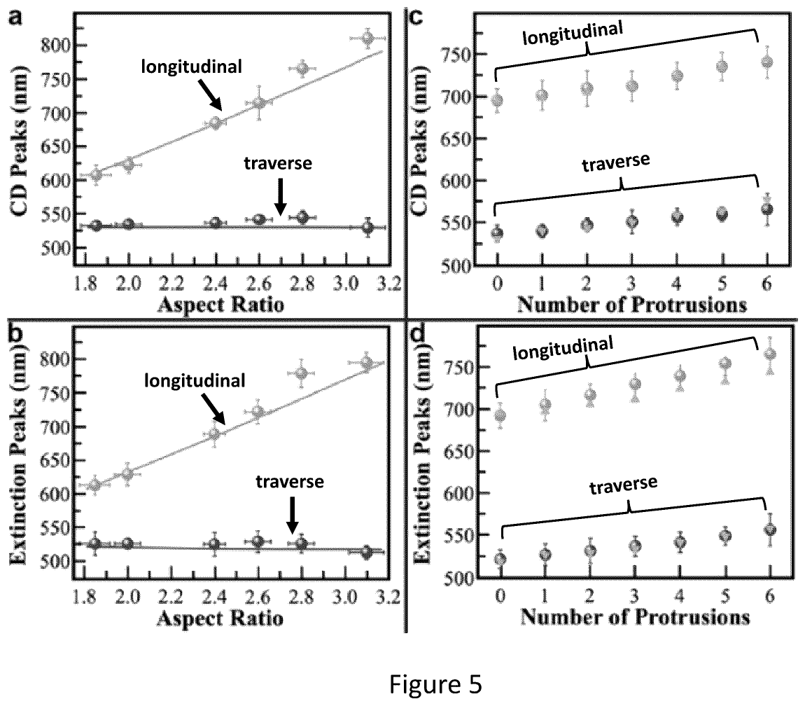

Understanding and Tuning Chiroptical Response of Au Nanorods. Our experimental observations and proposed mechanism of induced chirality in both Au NCs and NRs immediately suggest that such nanoscale chirality can be further engineered by designing and tailoring their dimensions and boundary morphology. FIG. 5 highlights two examples of such chirality control.

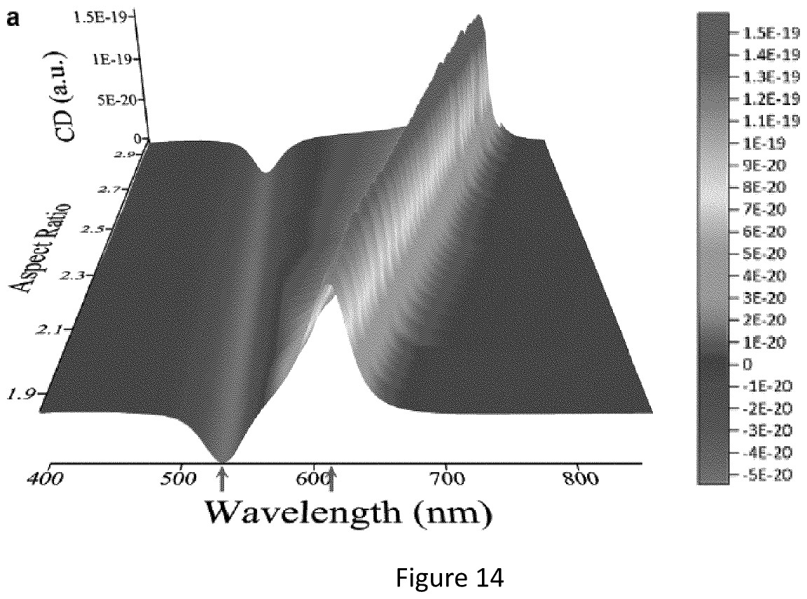

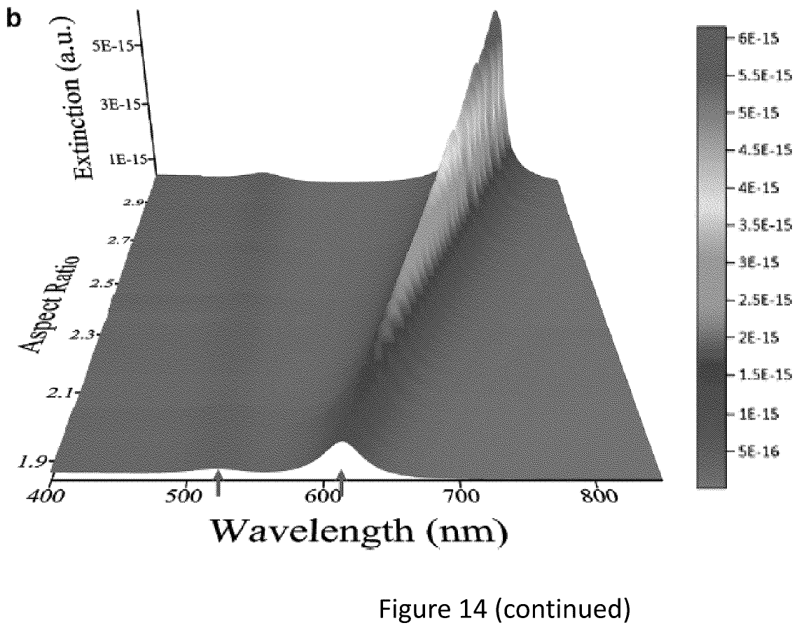

For regular achiral Au NRs, their optical properties have been demonstrated to be dependent on the AR. By using the present proposed CD mechanism and model of chiral Au NRs in FIG. 4, the evolution of both CD and extinction spectra were evaluated theoretically with the AR of chiral Au NRs while keeping the other structural parameters the same, and the results are shown in FIG. 14. Experimentally chiral Au NRs with different AR but a similar width of 18.3±0.5 nm were achieved (FIG. 15, panels a and b), and their CD and extinction spectra were measured with results presented in FIG. 13, panels d and c. It can be seen that although all samples with different ARs show similar characteristics in both CD and extinction spectra and both transverse and longitudinal LSPR modes are observed, the longitudinal mode in both CD and extinction spectra manifests strong dependence on the AR, but the transverse mode does not. In order to compare experimental with computational results, peak wavelengths of both transverse and longitudinal LSPR modes from the CD and extinction spectra were extracted and the results are summarized in FIG. 5, panels a, b, respectively. It can be clearly seen that the variation tendency seen in the present experimental results agree very well with the theoretical prediction, and both the CD and extinction wavelengths of the longitudinal mode show strong dependence on the AR, while the corresponding peak wavelength of the transverse mode remains almost unchanged, as it is mainly determined by the width of chiral Au NRs.

The observed CD of chiral Au NRs originates from the prevailing chiral facets exposed at the ends of chiral NRs, suggesting that, if such chiral facets (and thus the end morphology) can be tailored, it should offer an important way to finely tune chiroptical response and enhance its induced chirality. Indeed, by employing a layer-by-layer overgrowth process onto the starting chiral Au NRs, it was found that the boundary morphology at both ends of NRs evolves from a simple chiral elongated concave rhombic dodecahedron (FIG. 4) to a more intricate shape with multiple protrusions at the end, and the average number of such structural protrusions can be controlled from single protrusion to a bone-shaped morphology with more than six protrusions (FIG. 13, panels f and g). The appearance of protrusions can be understood by the kinetically controlled overgrowth condition, in which the overgrowth at corners is favored over facets. Optical measurements on a series of samples with different numbers of protrusions were performed and the results are summarized in FIG. 15, panels d and c. Based on the morphologies of protrusion structures, corresponding models (FIG. 13, panels f and g) were also constructed and their chiroptical responses were computed to account for the effect of such morphological protrusions (FIG. 15, panels f and g). In order to compare experimental with theoretical results and to validate the underlying CD origin and model, peak wavelengths from experimental and simulated CD and extinction spectra were acquired and the results are summarized in FIG. 5, panels c, d. It can be seen that both the CD and extinction spectra of resultant chiral Au NRs with protrusions vary consistently with total number of protrusions at the ends, which can be fully rationalized by the present modeling. The present work has demonstrated for the first time that the chiral mechanism based on chiral high-Miller-index facets can be applied to NRs to induce chirality and to further tailor corresponding chiroptical response at the nanoscale by combining with various structural controls. Thus far, the consistency between the experimental results and theoretical computations and modeling for all different chiral Au NCs and NRs has validated the proposed chiral mechanism in this important class of plasmonic chiral metal nanostructures, offering a general guideline to further tailor CD characteristics of chiral nanostructures from the bottom-up.

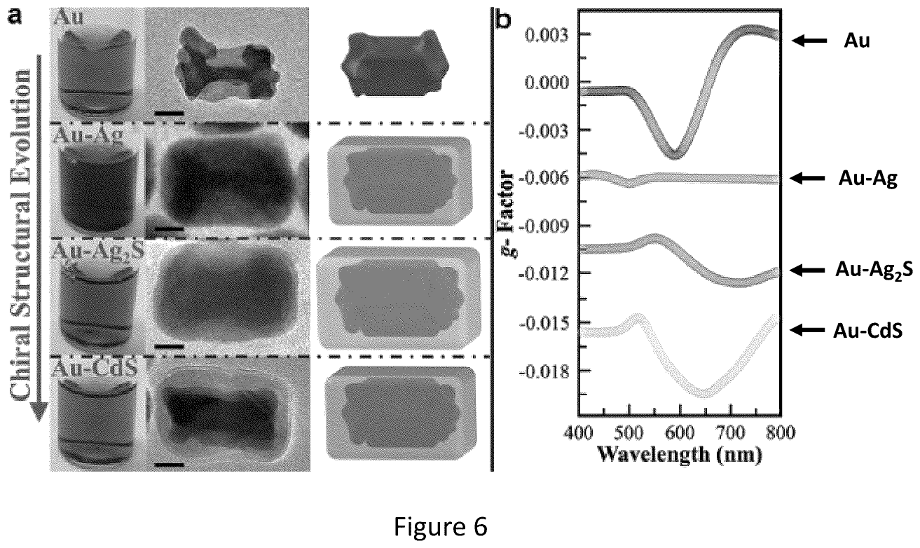

Chiral Hybrid Metal-Semiconductor Nanostructures. It is worth noting that, different from other mechanisms for inducing chirality in plasmonic nanostructures by either electromagnetic coupling or assembly, the boundary morphology-induced handedness of metal nanostructures has been demonstrated in FIG. 5 to be very robust with various controls, thus offering a viable bottom-up chiral material platform for developing more complex and functional chiral hybrid nanostructures that can potentially integrate different functionalities within a single nanoscale entity to enable synergistic couplings (FIG. 1) and to explore the emerging chirality-dependent physics and chemistry. For example, exotic nanoscale resonant plasmon-exciton coupling has been achieved in achiral hybrid metal-semiconductor nanostructures. If similar hybrid nanostructures can be achieved with chiral plasmonic nanostructures, like the chiral Au NCs and NRs from the current work, chirality should provide a new degree of freedom to control nanoscale spin or enantioselective photocatalysis by a chiral local plasmonic field. FIG. 6 demonstrates the feasibility to develop a new class of chiral hybrid nanostructures and to investigate the evolution of structural and optical characteristics in such hybrid nanostructures. The study started with chiral S—Au NRs with bone-shaped end morphologies that retain strong CD (FIG. 13, panel f). A plasmonic Ag shell is first grown onto these chiral Au NRs, followed by the chemical conversion of the metal Ag shell to semiconductor Ag₂S and CdS shells, while maintaining the chiral Au NR core unchanged during the whole multiple-step process. FIG. 6, panel a shows the step-by-step structural and compositional evolution characterized by TEM imaging, with a schematic model, and the corresponding variation of the Ag shell while the bone-shaped Au NRs remain intact and visible in the TEM images. The subsequent chemical conversions from the metal Ag to dielectric semiconductor shells (both Ag₂S and CdS) do not alter cither the overall cuboid morphology or the central bone-shaped Au core, highlighting the robustness of as-synthesized chiral Au NRs.

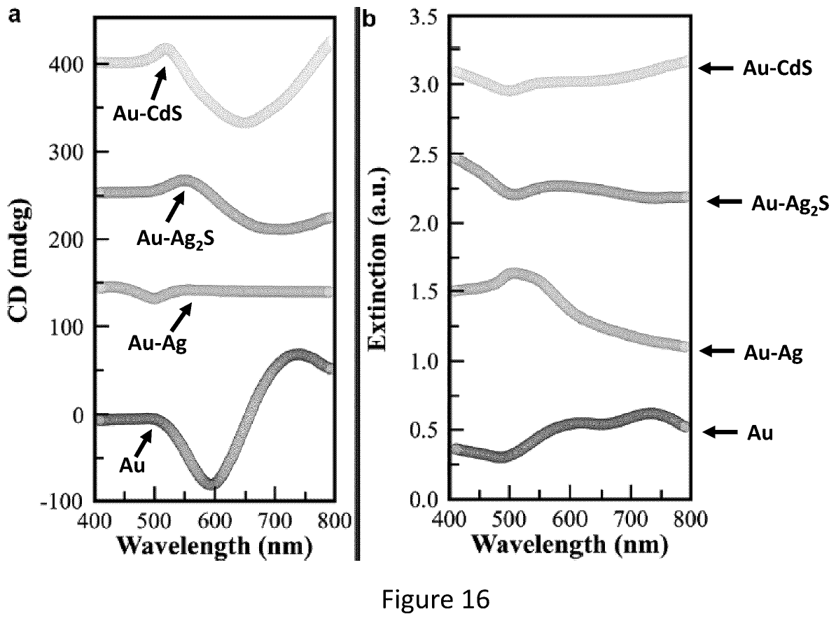

The evolution of CD characteristics were studied (FIG. 16) and the corresponding dimensionless dis-symmetry factor (g-factor) was compared in FIG. 6, panel b. There are a few important observations that can be immediately identified from FIG. 6, panel b: First and foremost, the hybrid Au—Ag₂S and Au—CdS nanostructures manifest strong CD that originates from the chiral Au NR core. This observation is consistent with the TEM result, confirming that chiral Au NRs remain intact even after multiple overgrowth and harsh chemical conversion processes. This again can be attributed to the robust chirality mechanism by chiral boundary morphology in FIG. 1. Second, the CD of the Au—Ag core-shell NRs almost disappears after overgrowth of the Ag shell but is recovered once the Ag shell is converted to the semiconductor Ag₂S shell in the Au—Ag₂S hybrid NRs. The revival of CD features in the Au—Ag₂S hybrid NRs suggest that the chirality of Au NRs is sustained in the process; however, the disappearance of CD in the Au—Ag core-shell NRs can be attributed to the fact that both Au and Ag are conductive and the overall morphology of the Au—Ag core-shell NRs becomes even, and the plasmonic electrons are delocalized on the surface of entire core-shell NRs. As a result, the effect of the chiral boundary morphology of Au NRs becomes negligible to the delocalized plasmonic electrons. Lastly, although the CD features are recovered in the hybrid Au—Ag₂S and Au—CdS metal-semiconductor NRs, both the CD peak wavelengths and intensities are varied as compared with the starting chiral Au NRs. Qualitatively, such variation can be attributed to the difference in the dielectric constant of the semiconductor shell in the hybrid nanostructures.

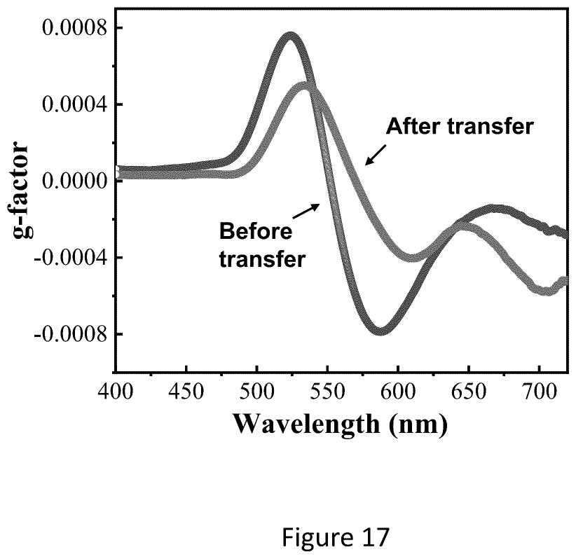

Phase transfer of chiral Au NCs from aqueous phase to oil phase: For preparation of S oil phase precursor, 128 mg S powder is added into 10 ml oleylamine and 20 ml oleic acid. The mixture is purged with N₂ and kept under the protection of N₂ for the whole process. The mixture is put in a 100° C. oil bath and kept stirring for 20 hrs. The S powder should be almost dissolved completely and gives a brown-orange colored solution. Undissolved S powder is removed by centrifugation at 8000 rpm for 10 mins. The supernatant is then diluted by 30 ml toluene and kept for future use. 1 ml chiral Au NCs suspension is centrifugated and redispersed into 1 ml DMF. Meanwhile, 0.4 ml S oil phase precursor is diluted by 2 ml toluene while stirring. The 1 ml chiral Au NCs suspension in DMF is added into the previous mixture drop by drop. The reaction of chiral Au NCs with the S oil phase precursor creates Au—S bonds at the surface of the chiral Au NCs and thus promotes the ligand exchange. The mixture is left for 1 hr stirring at room temperature and the chiral Au NCs are collected by centrifugation and redispersion into the mixture of 2 ml toluene and 100 ul oleylamine. The dispersion of chiral Au NCs in toluene is further improved by sonication in 50° C. water bath for 2 hrs and stirring overnight. As shown in FIG. 17, The preservation of CD of chiral Au NCs after phase transfer demonstrates the stability of geometrical chirality.

Thus, a facile synthetic method was developed to induce and engineer chiroptical response of small-sized plasmonic Au NCs and NRs from the bottom-up, having an achiral crystallo-graphic lattice. Both experimental and theoretical results have suggested that the observed chirality originates from the nanoscale chiral boundary morphology induced by the broken symmetry of chiral high-Miller-index facets and is very robust. Because of their small size and robustness of chirality, these as-synthesized nanoscale chiral plasmonic structures can serve as chiral functional building blocks. These results demonstrated a new class of chiral hybrid nanostructures that can integrate multifunctionalities, including chirality, plasmons, and excitons at the nanoscale. The current work opens up a few emerging research avenues. For example, although Au was utilized as an example, the chiral mechanism based on broken symmetry of chiral high-Miller-index facets should be general and be readily applied to other achiral inorganic metals. Compared with existing mechanisms for inducing chirality at the nanoscale, chiral boundary morphology in inorganic nano-crystals should offer a robust mechanism for preserving CD characteristics for many practical applications with unique tunability, including enantioselective catalysis and chiral plasmonic chemistry. For example, by tuning structural parameters such as the AR, the chiroptical response of chiral NRs can be finely tailored to match different energy landscapes in a chemical reaction, while the local chiral plasmonic field can be significantly enhanced in a chiral NR with controllable apex protrusions due to its induced large local curvature to facilitate asymmetric reactions. More importantly, the availability of hybrid chiral metal-semiconductor nanostructures as demonstrated in here should offer a new and unique pathway to analyze various entangled chirality effects, including chirality-induced spin selectivity and chiral hot electrons at the nanoscale.

### Example 2

Chemicals. Cetyltrimethylammonium bromide (CTAB), gold chloride trihydrate (HAuCl₄·3H2O, 99.9+%), Silver nitrate, sodium bromide, sodium hydroxide and sodium borohydride were purchased from Sigma-Aldrich. Cetyltrimethylammonium chloride (CTAC, >95%) was purchased from Tokyo Chemical Industry (TCI). L-cysteine, D-cysteine, ascorbic acid (AA), cadmium nitrate tetrahydrate was purchased from Acros. Tri-n-butylphosphine (TBP, 97%) was purchased from Strem Chemicals. Sodium sulfide nonahydrate was purchased from Alfa Aesar. Deionized water (DI; Milli-Q, >18.0 MΩ) was used in all experiments. All chemicals were used as received without further processing.

Synthesis of chiral Au NCs. The achiral Au seed NCs are synthesized by a revised seed-mediated method. Typically, a 0.5 ml of achiral Au seed NCs solution is added into 1.5 ml of 80 mM CTAC solution. A 10˜25 μl of 70 μM L-cysteine (or D-) solution is added and the mixed solution is kept stirring for 30 mins to adsorb the cysteine molecules on the surface of Au NCs. The mixed solution is centrifugated by 13200 rpm for 10 mins and the supernatant is discarded to remove the extra cysteine molecules in solution. This centrifugation process is repeated twice, redispersing each time in DI water. The precipitate is then redispersed into 0.5 ml of DI water, followed by addition of 1.5 ml of 80 mM CTAC solution and 100 μl of 0.1M ascorbic acid under stirring. A 500 μl of 1 mM HAuCl₄ solution is slowly injected into the mixture solution by syringe pump for 30 minutes. The products (i.e., chiral Au NCs) are washed out by centrifugation and redispersed into the DI water.

Synthesis of chiral Au NRs. The growth of chiral Au NRs starts with preparation of seed solution, in which a 5 ml of 0.2 M CTAB solution is mixed with 5 ml of 0.5 mM HAuCl₄, followed by addition of 0.6 ml of ice-cold 0.010 M NaBH₄ under vigorous stirring for 2 mins and then aged for 30 mins before further usage. A 5 ml of 0.2 M CTAB is mixed with 0.1 ml of 4 mM AgNO₃ solution and 5 ml of 1 mM HAuCl₄ solution, and after gentle mixing by hand shaking of the solution, 70 ul of 0.1M ascorbic acid is added. This step is followed by addition of 12 μl of the above seed solution. After aging for 12 hrs, the mixture is centrifuged at 13200 rpm for 10 mins, and the precipitate (i.e., achiral Au NRs) is re-dispersed in 2 ml of DI water as seed NRs for the subsequent overgrowth of chiral Au NRs. For the growth of chiral Au NRs, a 1 ml of above Au seed NRs solution is mixed with 1 ml of 80 mM CTAC and 10 μl of 0.3 mM L- (or D-) cysteine molecule. The mixture solution is aged for 1 h. After aging, a 10 μl of 5 mM HAuCl₄ and 0.2 ml of 0.1M ascorbic acid is added and aged for 1 h. Then the solution is centrifuged at 13200 rpm for 10 mins to get the Au NRs and repeated twice and dispersed in 2 ml of 80 mM CTAC.

A 30 μl of 5 mM HAuCl₄ solution and 0.2 ml of 0.1 M ascorbic acid is added to the above solution, followed by aging for 1 h. After aging, the solution is centrifuged twice at 13200 rpm for 10 mins, and the chiral product is re-dispersed in 2 ml of 80 mM CTAC. Similar overgrowth condition is repeated to grow chiral Au NRs with different aspect ratio and protrusions (including chiral Au NRs with bone-shaped end morphology).

Synthesis of chiral hybrid nanostructures (chiral Au—Ag, Au—Ag₂S and Au—CdS NRs). Typically, a 2 ml of chiral Au NRs is mixed with 1 ml of 0.2 M CTAB, 30 ul of 0.01 M AgNO3 and 50 μl of 0.1 M ascorbic acid. The pH of the solution is adjusted to ˜10 by using NaOH. After aging for 5 mins, the solution is centrifuged twice at 13200 rpm for 10 min, and the product (Au—Ag NRs) is re-dispersed in 2 ml of 0.2 M CTAB. To convert metal Ag shell of Au—Ag NRs to semiconductor Ag₂S shell, the above Au—Ag core-shell NRs solution is mixed with 20 ul of 0.4 M Na₂S solution. After aging for 30 mins, the solution is centrifuged twice at 13200 rpm for 10 min, and the product (chiral Au—Ag₂S NRs) is dispersed in 2 ml of 0.2 M CTAB. The chiral Au—CdS NRs is achieved by cation exchange process. Typically, the above Au—Ag₂S NRs solution is mixed with 20 μl of 80 mM Cd(NO₃)₂ solution. The solution is stirred at 60° C., followed by addition of 5 μl of tributylphosphine. The cation exchange process continues for 2 hrs. The solution is centrifuged twice at 13200 rpm for 10 mins, and the product (chiral Au—CdS NRs) is dispersed in DI water.

Construction of chiral structural models for simulation. All models for the current work have been constructed by using the SOLIDWORKS 2016, and then imported to the COMSOL Multiphysics 5.5 software for optical simulations without further modification. The procedures for constructing different models are described step-by-step as follows.

Chiral NCs. From electron microscopy characterizations (TEM and SEM), concave features in the as-synthesized chiral NCs was confirmed, confirming the appearance of high Miller index facet and offering the basis to construct models. To facilitate visual differentiation, two different colors were utilized to represent two categories of chiral facets with opposite handedness: red for R-facets and blue for S-facets. A schematic model was first constructed in SOLIDWORKS. For an achiral NC with concave morphology, the R- and S-facets are symmetrically distributed in space (middle of FIG. 3, panel a). Once such symmetry is broken, one dominant structural chirality can thus be formed. Based on that, one specific chiral facet (i.e., red or blue) was extended in space to become dominant on the surface of a chiral NC depending on its chirality. For example, as shown in the middle of FIG. 3, panel b, there are four segments of S-facets in one concave surface of achiral NC. With in-plane spatial extension of S-facets, these S-facets could intersect at the edges of a NC, forming those twisting sites shown on the left of FIG. 3, panel a. Vice versa, a schematic model of R—NC can be created by the in-plane spatial extension of R-facets. Once the schematic model is constructed, its edges and corners are smoothed by using the “Filet” function of SOLIDWORKS, and the size of filet is 5 nm.

Chiral NRs. Chiral NR model was constructed based on a concave elongated rhombic dodecahedron. From the structural characterizations, it was determined that chiral Au NRs possess undistorted straight axis and concave end morphology. Similar to achiral NCs, there are symmetrical distribution of S- and R-facets at both ends of an achiral NR. To induce chirality, the same construction method as described for chiral NCs was followed by extending and cutting one specific type of chiral facets at both ends of the NR. For example, the S—NR is constructed by in-plane extension of S-facets at both ends while maintaining rhombic dodecahedron shape, resulting in three dominant S-facets around one (111) corner (left of FIG. 4, panel a) with twisted edges. By viewing from (111) directions, the edges around one apex corner can be deemed as twisted counterclockwise. Similarly, for the model of R—NR, extending and cutting R-facets at both ends can lead to clockwise twisting of edge around (111) corner (right of FIG. 4, panel a). Once the schematic model is constructed, its edges and corners are smoothed by using the “Filet” function of SOLIDWORKS and the size of filet is 3 nm. (3) Chiral NRs with different AR and protrusions. Based on the simulation model of chiral NRs, the results from the TEM images was followed exactly to manually change length and width of NRs in order to change the AR as well as the number and configuration of apex protrusions to match with images (typical comparison between model and images are provided in FIGS. 13 and 15).

FEM simulation by COMSOL. FEM simulation was performed to evaluate both extinction and CD properties of chiral nanostructures by using a commercial COMSOL Multiphysics 5.5 software. The 3D models of chiral Au NCs and chiral Au NRs are firstly constructed by using a different commercial 3D modeling software (SOLIDWORKS), and then are imported to the FEM solver (COMSOL). The chiral Au NC and NR model are encapsulated by a spherical shell with size of the maximum excitation wavelength as the achiral environment and its outer surface set as perfect matching layer (PML) boundary. For the current work, the dielectric function of environment is always set to be that of water in order to simulate the measurement condition (in DI water). The optical response of the hybrid nanostructure is computed by illumination of left and right circularly polarized plane waves with incident wave vector k. For the chiral Au NC, because of the low anisotropy, only the incident wave in one direction was calculated. For the chiral Au NR, the calculated CD is averaged over wave vector k along and perpendicular to the NR. The dielectric function of Au is from the previous literature.

Characterizations. For TEM characterization, all samples were prepared by adding one drop of solution containing desired nanostructures onto 300 mesh copper grids with carbon support film (Ted Pella, 01820). A JEM 2100 LaB6 and a JEM 2100 FEG TEM/STEM equipped with a field emission gun from Maryland Nanocenter at the University of Maryland were applied. Typical TEM imaging parameters were: 200 keV electron landing energy, 108 μA beam current, 0.5 s acquisition time and 2004 pixel by 1336 pixel digital resolution.

For SEM imaging of nanoscale objects contamination-free imaging is indispensable. Sample cleanliness was found to be critical for the imaging of the chiral nanostructures. Even with SEMs capable of sub-nanometer focusing of the primary electron beam, fine details of the sample can be easily obscured, and in some severe cases can become unrecognizable due to the deposition of carbonaceous molecules. The precursor molecules could come from the instrument and/or from the sample. Samples for high resolution angle-dependent SEM characterization were washed extensively in distilled water (18.2 MΩ·cm) for at least four times in order to remove excess chemicals before drop casting to 5 mm by 5 mm chips, which were diced from silicon wafer (1 Ω·m resistivity, prime, 200 mm). The chips had only native, approximately 1 nm thin silicon oxide on top. After deposition, the sample were rinsed again in distilled water. Before imaging, the SEM was cleaned by low-energy plasma cleaning to the extent that on a reference silicon chip no contamination could have been detected at 45 times higher area dose than the area dose used for imaging the sample. Sample cleaning was further performed by low-energy electron irradiation. The SEM was equipped with a double-tilt and rotation sample stage that allowed for imaging the Au NCs and NRs from various directions. Typical SEM imaging parameters were: 15 keV electron landing energy, 43 nA beam current, 50 us pixel dwell time, and 1024 pixel by 884 pixel digital image resolution.

The CD and extinction spectra were simultaneously acquired on a commercial JASCO J-815 CD spectrometer at room temperature using a cuvette with light path of 1.0 cm.

Notation of handedness induced by chiral boundary morphology and its relationship to the organic chiral molecules utilized during the growth. The chiral boundary morphology in the current work originates from the broken symmetry of chiral high Miller index facets on the surface of an inorganic crystalline lattice. Au was used as an example to denote its associated handedness. The crystal structure of Au is face-centered cubic (fcc) with no intrinsic lattice chirality. A high Miller index plane with index of (hkl), where h≠k≠l and hkl≠0, cannot be superimposed by its mirror image by any combination of rotations and translations. This crystalline plane is defined as a chiral plane, with one example of (321) plane shown in the FIG. 7. In general, from the viewpoint of atomic structure, such high Miller index chiral plane can be signified by a micro unit cell (with in-plane translation) consisting of atomic kink site that acts as the interconnect of an ordered combination of symmetric Miller planes like (100), (110) and (111), mimicking a chiral center from an organic chiral molecule. To that, Attard's notation was followed to assign an R- or S-designation to a high Miller index chiral plane: when viewing from above a chiral plane (see for example FIG. 7, panel c), if its interconnected symmetric low Miller index microfacets around the atomic kink site are oriented clockwise from the most densely packed microfacet to the least densely packed one, it is defined as R-chiral plane, and vice versa for the S-chiral plane. For example, the R-(321) (or (321)) plane in Supplementary FIG. 7, panel c has a clockwise conformation of (111)→(100)→(110), while the S-(321) manifest a counterclockwise conformation of (111)→(100)→(110). Because of the crystal symmetry as shown in FIG. 7, panel a, although there exist many high Miller index chiral planes in a bulk achiral crystal, their effects are cancelled out. Nevertheless, the symmetry between two chiral planes with opposite handedness can be broken on the surface.

It has been demonstrated both experimentally and theoretically that there exist enantioselective interactions between chiral organic molecules and inorganic chiral planes defined above. In general, the L-cysteine molecules consistently show enantioselective binding on high Miller index chiral R-facets, while D-cysteine molecules favor occupation onto the chiral S-facets. For example, the DFT calculations have shown that the adsorption energy of L-cysteine on R-(321) is higher than that on S-(321), leading to enantioselective binding of L-cysteine on R-(321). Furthermore, higher adsorption of D-cysteine molecules on the Au's S-(17 11 9) facets over L-cysteine molecules has been confirmed by both the angle scanned x-ray photoelectron diffraction and DFT calculation. Chiral Au NCs were employed as an example to rationalize the bottom-up chiral growth and control. The concave morphology after overgrowth is induced by the kinetically controlled condition. Because of protective binding of CTA+ ions to the (100) facets, the Au atoms are preferably added to <111> corners and <110> edges. Under kinetically controlled condition, the deposition rate of Au atoms at corners and edges is preferred, actuating the formation of high Miller index facets with resultant concave morphology. Meanwhile, the symmetry of chiral high Miller index facets is broken by the enantioselective binding of L-cysteine onto the R-facets (vice versa, D-cysteine onto the S-facets). As a consequence, the Au deposition onto the corresponding chiral facets is reduced and their outward growth is thus inhibited. It is worth noting that according to the present synthetic recipe, the chiral molecules are introduced before the overgrowth of Au onto the seeds without further addition during the subsequent overgrowth process. Therefore, the chiral molecules play an influential role in controlling overgrowth of chiral nanostructures kinetically instead of thermodynamically.

To sum up, the direct consequence of introduction of chiral molecules in the growth process is to induce the biased kinetic overgrowth rate favoring chiral facets with opposite handedness on the surface of an inorganic crystalline nanostructure. To that, in the current work chiral NCs and NRs synthesized by the assistance of L-cysteine molecules was designated as S—NCs/NRs, while their enantiomers, R—NCs/NRs are the resultants from D-cysteine molecules employed in the growth process. Although the fcc lattice is used as an example to illustrate basic concepts and notations, the enantiospecific kinetically controlled strategy and notations can be applied to other crystallographic lattices.

1. A chiral metal nanomaterial comprising a metal forming a nanostructure having controllable imbalanced chiral facets on the surface of the nanostructure.

2. The chiral metal nanomaterial of claim 1, wherein the metal is gold, platinum, cobalt, copper, nickel, silver, iron, palladium, aluminum, tin, lead, or alloys thereof.

3. (canceled)

4. The chiral metal nanomaterial of claim 1, wherein the nanostructure comprises nanocubes, nanorods, nanocuboctahedra, nanooctahedra, nano-triangular plates, nano-hexagonal plates, nanobars, nanodendrites, nano-bi pyramids, nanodecahedra, nano-icosahedrons, nanopolyhedrons, nanocages, nano-rhombic dodecahedra, nanotetrahedrons, nanobeams, or a combination thereof.

5. (canceled)

6. (canceled)

7. (canceled)

8. A method of preparing a chiral metal nanomaterial having controllable imbalanced chiral facets, comprising:
mixing a seed metal nanomaterial, a chiral organic compound, a surfactant, reducing agent, and a metal precursor to form a growth medium, whereby the chiral metal nanomaterial having controllable imbalanced chiral facets is produced.

9. (canceled)

10. The method of claim 8, comprising:
mixing the seed metal material, the chiral organic compound, and the surfactant to form a first suspension;
generating a first precipitate from the first suspension;
resuspending the first precipitate to form a second suspension; and
adding the surfactant, the reducing agent, and the metal precursor to the second suspension to form the growth medium.

11. (canceled)

12. (canceled)

13. The method of claim 8, comprising:
mixing the surfactant, sodium borohydride (NaBH₄), and the metal precursor to form a third suspension;
adding the third suspension to a solution comprising the surfactant, silver nitrate, the reducing agent, and the metal precursor to form a fourth suspension;
generating a second precipitate from the fourth suspension;
resuspending the second precipitate to from a fifth suspension; and
adding the chiral organic molecule, the surfactant, the reducing agent, and the metal precursor to the fifth suspension to form the growth medium.

14. (canceled)

15. (canceled)

16. (canceled)

17. (canceled)

18. (canceled)

19. (canceled)

20. (canceled)

21. The method of claim 8, wherein the metal is gold.

22. The method of claim 8, wherein the seed metal nanomaterial comprises nanocubes, nanorods, nanocuboctahedra, nanooctahedra, nano-triangular plates, nano-hexagonal plates, nanobars, nanodendrites, nano-bi pyramids, nanodecahedra, nano-icosahedrons, nanopolyhedrons, nanocages, nano-rhombic dodecahedra, nanotetrahedrons, nanobeams, or a combination thereof.

23. The method of claim 8, wherein the surfactant comprises C₁₀₋₂₀alkyltrimethylammonium bromides or C₁₀₋₂₀alkyltrimethylammonium chloride.

24. The method of claim 8, wherein the reducing agent comprises ascorbic acid, sodium borohydride (NaBH₄), or a combination thereof.

25. The method of claim 8, wherein the metal precursor comprises HAuCl₄.

26. The method of claim 8, wherein the chiral organic compound comprises an amino acid.

27. The method of claim 26, wherein the amino acid is L-cysteine, D-cysteine, L-glutathione, or D-gluathione.

28. A chiral metal nanomaterial produced by the method of claim 8.

29. (canceled)

30. (canceled)

31. (canceled)

32. A method of producing a chiral hybrid nanomaterial comprising chiral metal and semiconductor, the method comprising,
(a) mixing a chiral metal nanomaterial with a silver salt, a surfactant, and a reducing agent in a first medium, thereby producing an intermediate hybrid nanomaterial comprising silver, wherein the chiral metal nanomaterial comprises a metal forming a nanostructure having controllable imbalanced chiral facets on the surface of the nanostructure; and
(b) mixing the intermediate nanomaterial with an anion X in a second medium, thereby producing a first chiral hybrid nanomaterial comprising Ag—X semiconductor.

33. The method of claim 32, further comprising
(c) mixing the first chiral hybrid nanomaterial comprising Ag—X semiconductor and a cation M′ in a third medium, thereby producing a second chiral hybrid nanomaterial comprising M′-X semiconductor.

34. (canceled)

35. (canceled)

36. The method of claim 32, wherein X is O²⁻, S²⁻, Se²⁻, or Te²⁻, or a combination thereof.

37. The method of claim 32, wherein M′ is Cu⁺, Au⁺, Cd²⁺, Zn²⁺, Mn²⁺, Fe²⁺, Co²⁺, Al³⁺, Ag⁺, Sn²⁺, Ni⁺, Pt⁺, Pd⁺, or Pb²⁺, or a combination thereof.

38. (canceled)

39. (canceled)

40. The method of claim 32, wherein the surfactant comprises C₁₀₋₂₀alkyltrimethylammonium bromides or C₁₀₋₂₀alkyltrimethylammonium chloride.

41. (canceled)

42. (canceled)

43. (canceled)

44. (canceled)

45. (canceled)

46. A chiral hybrid nanomaterial comprising semiconductor produced by the method of claim 32.
